(19) United States
(12) Patent Application Publication
(10) Pub. No.: US 2020/0262705 A1
(43) Pub. Date: Aug. 20, 2020

(54) Process for controlling structure and/or properties of carbon and boron nanomaterials

(71) Applicant: 2D FLUIDICS PTY LTD, Nedlands (AU)

(72) Inventors: Kasturi Vimalanathan, Sturt (AU); Colin Llewellyn Raston, Blackwood (AU); Xuan Luo, Ascot Park (AU); Boediea Saad B Al Harbi, Ascot Park (AU); Thaar Muqhim D Alharbi, Buraydah City (SA)

(21) Appl. No.: 16/348,511

(22) PCT Filed: Nov. 10, 2017
(86) PCT No.: PCT/AU2017/000237

§ 371 Date: May 9, 2019

(30) Foreign Application Priority Data
Nov. 10, 2016 (AU) 2016904591

(51) Int. Cl. C01B 32/16; C01B 32/159; C01B 32/176; C01B 32/18

(52) U.S. Cl. CPC C01B 32/16; C01B 32/159; C01P 2004/16; C01B 32/18; C01P 2004/133; C01B 32/176

(57) ABSTRACT

Processes for altering the structure and/or properties of carbon nanomaterials and inorganic nanomaterials, such as boron nitride nanotubes are described. The processes can be used to produce a carbon nanotube product comprising predominantly carbon nanotube (CNTs) having a desired average length. The processes can also be used to fabricate carbon nanodots. The processes can also be used to slice inorganic nanotubes or nanowires. The processes can also be used to form supramolecular fullerene assemblies.

PRIORITY DOCUMENT

The present application claims priority from Australian Provisional Patent Application No. 2016904591 titled “PROCESSES FOR CONTROLLING STRUCTURE AND/OR PROPERTIES OF CARBON AND BORON NANOMATERIALS” and filed on 10 Nov. 2017, the content of which is hereby incorporated by reference in its entirety.

### TECHNICAL FIELD

The present invention relates to processes for altering the structure and/or properties of carbon nanomaterials, such as carbon nanotubes and fullerenes, and boron nanomaterials, such as boron nitride nanotubes.

### BACKGROUND

Carbon and inorganic nanomaterials of various dimensionalities have attracted significant attention due to their exceptional electrical, thermal, chemical and mechanical properties. There is a need for new processes for the fabrication of new forms of carbon nanomaterials and inorganic nanomaterials where possible devoid of stabilizing agents, and avoiding the use of harsh chemicals, with control over the shape, size and morphology, as a route to tailor their properties for specific applications.

For example, carbon nanotubes (CNTs) are one-dimensional cylindrical structures consisting entirely of carbon atoms that are used for a diverse range of applications such as in electronic devices, sensors, nanocomposite materials and drug delivery. Despite exhibiting extraordinary properties, there are a number of challenges in fabricating them which can limit their potential for use in applications. CNTs are usually grown millimeters in length with high degrees of bundling and aggregation of the strands. Thus, processing them within a liquid medium typically requires the use of surface active molecules, a high degree of functionalization, the use of toxic and harsh chemicals and long and tedious processing methods, and often with limited uniformity of the resulting material²⁻⁵. Current methods to overcome the problems associated with aggregation of CNTs are directed at controlling the length of CNTs at the nanoscale dimensions, using high-energy sonication, lengthy processing times and the use of toxic chemicals. Such processing can chemically alter the surface of the CNTs with consequential change to their chemical and physical properties, thereby limiting their applications. Developing methodologies to ease the processing of CNTs while maintaining the pristine nature of the material to be incorporated in applications is an important step forward in the use of these materials.

Other carbon nanomaterials, such as carbon nanodots, C₆₀, C₇₀ and the like, and inorganic nanomaterials, such as boron nitride nanotubes, have wide and varied applications but can suffer from similar problems in terms of producing the materials in a desired form and with a high degree of functionalization but without the use of surface active molecules, toxic and harsh chemicals and long and tedious processing methods.

There is thus a need to provide processes for enhancing and/or controlling properties and/or structures of carbon nanomaterials such as carbon nanotubes and fullerenes and inorganic nanomaterials, such as boron nitride nanotubes.

### SUMMARY

According to a first aspect, there is provided a process for producing a carbon nanotube product comprising predominantly carbon nanotubes (CNTs) having a desired average length, the process comprising:
providing a composition comprising starting CNTs;
introducing the composition comprising starting CNTs to a thin film tube reactor comprising a tube having a longitudinal axis, wherein the angle of the longitudinal axis relative to the horizontal is between about 0 degrees and about 90 degrees;
rotating the tube about the longitudinal axis at a predetermined rotational speed;
exposing the CNT composition in the thin film tube reactor to laser energy at a predetermined energy dose; and
recovering the single walled carbon nanotube product comprising predominantly CNTs having a desired average length from the thin film tube reactor,
   wherein the predetermined rotational speed is from about 6000 rpm to about 7500 rpm, the predetermined energy dose is from about 200 mJ to about 600 mJ and the values of the predetermined rotational speed and the predetermined energy dose are selected to produce CNTs having an average length of from about 50 nm to about 700 nm.

In some embodiments of the first aspect, the CNTs are single wall carbon nanotubes (SWCNTs). In some other embodiments of the first aspect, the CNTs are multi walled carbon nanotubes (MWCNTs).

According to a second aspect, there is provided a process for producing a single walled carbon nanotube product comprising single walled carbon nanotubes (SWCNTs) enriched in either a metallic chirality or a semiconducting chirality, the process comprising:
providing a composition comprising starting SWCNTs having metallic and semiconducting chiralities;
introducing the composition comprising starting SWCNTs to a thin film tube reactor comprising a tube having a longitudinal axis, wherein the angle of the longitudinal axis relative to the horizontal is between about 0 degrees and about 90 degrees;
rotating the tube about the longitudinal axis at a rotational speed;
exposing the composition comprising starting SWCNTs in the thin film tube reactor an energy source; and
maintaining the tube at the rotational speed and exposing the composition comprising starting SWCNTs to energy from the energy source for a time sufficient to produce the single walled carbon nanotube product comprising SWCNTs enriched in either a metallic chirality or a semiconducting chirality.

In some embodiments of the second aspect, the energy source is a light source. In certain of these embodiments, the light source is a laser.

According to a third aspect, there is provided a process for dethreading double walled carbon nanotubes (DWCNTs) and multi walled carbon nanotubes (MWCNTs) to produce single walled carbon nanotubes (SWCNTs) therefrom, the process comprising:
providing a composition comprising DWCNTs and/or MWCNTs, a liquid phase and a surfactant;
introducing the composition to a thin film tube reactor comprising a tube having a longitudinal axis, wherein the angle of the longitudinal axis relative to the horizontal is between about 0 degrees and about 90 degrees;
rotating the tube about the longitudinal axis at a rotational speed;
exposing the composition in the thin film tube reactor to light energy; and
maintaining the tube at the rotational speed and exposing the composition to the light energy for a time sufficient to produce SWCNTs.

According to a fourth aspect, there is provided a process for forming toroidal carbon nanoforms from single walled carbon nanotubes (SWCNTs), the process comprising:
providing a water/hydrocarbon solvent dispersion of SWCNTs;
introducing the dispersion to a thin film tube reactor comprising a tube having a longitudinal axis, wherein the angle of the longitudinal axis relative to the horizontal is between about 0 degrees and about 90 degrees;
rotating the tube about the longitudinal axis at a rotational speed and in a rotational direction under conditions to form toroidal carbon nanoforms from the SWCNTs.

According to a fifth aspect, there is provided a process for fabricating carbon nanodots, the process comprising:
providing or forming an aqueous composition comprising oxidised multiwalled carbon nanotubes (MWCNTs);
introducing the aqueous composition to a thin film tube reactor comprising a tube having a longitudinal axis, wherein the angle of the longitudinal axis relative to the horizontal is between about 0 degrees and about 90 degrees;
rotating the tube about the longitudinal axis at a rotational speed;
exposing the aqueous composition in the thin film tube reactor to light energy; and
maintaining the tube at the rotational speed and exposing the aqueous composition to the light energy for a time sufficient to produce carbon nanodots.

According to a sixth aspect, there is provided a process for slicing inorganic nanotubes or nanowires, the process comprising:
providing a solvent dispersion of starting inorganic nanotubes or nanowires;
introducing the solvent dispersion of starting inorganic nanotubes or nanowires to a thin film tube reactor comprising a tube having a longitudinal axis, wherein the angle of the longitudinal axis relative to the horizontal is between about 0 degrees and about 90 degrees;
rotating the tube about the longitudinal axis at a predetermined rotational speed;
exposing the solvent dispersion of starting inorganic nanotubes or nanowires in the thin film tube reactor to light energy; and
recovering sliced inorganic nanotubes or nanowires.

According to a seventh aspect, there is provided a process for removing defects in single walled carbon nanotubes (SWCNTs), the process comprising:
providing a solution or dispersion of oxidised SWCNTs;
introducing the solution or dispersion of oxidised SWCNTs to a thin film tube reactor comprising a tube having a longitudinal axis, wherein the angle of the longitudinal axis relative to the horizontal is between about 0 degrees and about 90 degrees;
rotating the tube about the longitudinal axis at a predetermined rotational speed;
exposing the solution or dispersion of oxidised SWCNTs in the thin film tube reactor to light energy; and
recovering reduced defect SWCNTs.

According to an eighth aspect, there is provided a process for forming supramolecular fullerene assemblies, the process comprising:
providing a fullerene solution comprising one or more fullerenes;
introducing the fullerene solution to a thin film tube reactor comprising a tube having a longitudinal axis, wherein the angle of the longitudinal axis relative to the horizontal is between about 0 degrees and about 90 degrees;
rotating the tube about the longitudinal axis at a predetermined rotational speed;
recovering supramolecular fullerene assemblies.

### BRIEF DESCRIPTION OF DRAWINGS

Embodiments of the present invention will be discussed with reference to the accompanying figures wherein:

FIG. 1 shows a plot of length distribution of sliced SWCNTs with an average length of 40-50 nm;

FIG. 2 shows (a and b) AFM height images of oxidized MWCNTs (O-MWCNTs); (c) AFM height image of sliced O-MWCNTs in the presence of a mixture of NMP and water with its associated length distribution plot; and (d) AFM height image of sliced O-MWCNT in the presence of water with its associated length distribution plot;

FIG. 3 shows AFM height images with its associated length distribution plot showing evidence of the ability to control the length of SWCNT and MWCNT;

FIG. 4 shows optical absorption spectra and Raman analysis. (a) Ultraviolet-visible-infrared absorption spectra of as received semiconducting and metallic SWCNTs and the separated SWCNTs with the majority of the tubes of metallic chirality and the semiconducting S₂₂ chirality, (b) the G-mode region of as received SWCNTs and the separated metallic SWCNTs, and the (c) radial breathing mode (RBM) analysis of the as received SWCNTs and the separated metallic SWCNTs;

FIG. 5 shows photoluminescence excitation spectra of (a) pristine as received SWCNTs and (b) separated SWCNTs after a single pass in the VFD while simultaneous pulsed with a Nd:YAG laser operating at 1064 nm and 260 mJ;

FIG. 6 shows Raman analysis of the radial breathing mode (RBM) region of CNTs in water for (a) as received DWCNTs, (b-e) DWCNT after dethreading, (f-g) AFM height images of sliced SWCNTs in water which are derived from DWCNTs;

FIG. 7 shows Raman analysis of the radial breathing mode (RBM) region of SWCNTs in a mixture of NMP/water for (a) as received DWCNTs, (b-c) DWCNT after dethreading in situ, and (d) length distribution plot of sliced SWCNTs derived from DWCNTs, with an average length of ca 370 nm;

FIG. 8 shows AFM height images (a) SWCNTs with two ends in contact with each other, and (b-c) chiral figure of ‘8’; note that the chirality in (c)-(f) is the same, whereas the chirality in (b) which is from a different sample is the opposite;

FIG. 9 shows a schematic for the fabrication of the Cdots from MWCNTs using the VFD and a pulsed Nd:YAG laser;

FIG. 10 shows Cdots generated at θ=45° and rotational speed of 7500 rpm at a laser power of 260 mJ. (a) AFM image and analysis (inset) of two Cdots, indicating a sample height of 3-10 nm. (b) SEM image of as prepared sample and (c) TEM and HRTEM images of Cdots;

FIG. 11 shows Raman spectroscopy of the Cdots. (a) SEM image of area mapped. (b) Optical image of region highlighted with the red box. (c) Mapping for D band. (d) Mapping of the G band. (e) Raman spectra of the Cdots. Circles in (c) and (d) highlight positions from which spectra where taken in (e). Scanned area was 20×20 μm² and scale bar is 5 μm;

FIG. 12 shows the fabrication of Cdots in H₂O₂. (a) SEM images at different speeds of centrifugation. (b) Size distribution plots. (c) Raman spectra measured with using a 532 nm laser;

FIG. 13 shows the deconvolution of the XPS C1s for (a) as received MWCNTs, and (b) laser VFD processed MWCNTs in H₂O₂;

FIG. 14 shows (a) AFM images of Cdots generated from processing O-MWCNTs in NMP:water system with its associated size distribution plot. (b) AFM images of Cdots generated from processing O-MWCNTs in water system with its associated size distribution plot. Each plot was based on over 100 AFM-imaged particles;

FIG. 15 shows AFM images of products obtained from the continuous flow VFD processing of MWCNTs (0.5 mg/mL, flow rate of 0.45 mL/min) under pulsed laser irradiation (1064 nm, 260 mJ) at 45o tilt and different rotational speeds. (a) 5000 rpm. (b) 6500 rpm. (c) 7500 rpm. (d) 8000 rpm. Samples were centrifuged at 1180×g for 30 min after VFD processing and the supernatant was drop-casted on a silicon wafer for AFM imaging. The average dimension of as received MWCNT is O.D.×I.D.×L equivalent to 10 nm±1 nm×4.5 nm±0.5 nm×3-6 μm. An average of ten areas were randomly chosen for all AFM images, with 1-2 representative images presented in this figure;

FIG. 16 shows a Raman map of Cdots fabricated under continuous flow VFD processing (0.5 mg/mL, 0.45 mL/min, 7500 rpm) under pulsed laser irradiation (1064 nm, 450 mJ) at 45° tilt. (a) AFM images of the mapping area. (b) Optical images of the mapped area (highlighted in the red square) and three representative Raman spectra circled in (c) mapping the D band (1342 cm⁻¹), G band (1595 cm⁻¹) and a broad band (2030 cm⁻¹-3663 cm⁻¹) from left to right, respectively. Scanned area was 20×20 μm²;

FIG. 17 shows AFM images of products obtained from the continuous flow VFD processing of MWCNTs (flow rate of 0.45 mL/min, 7500 rpm) under pulsed laser irradiation (1064 nm, 450 mJ) at 45° tilt, with different sample concentrations. (a) MWCNTs at 0.5 mg/mL without laser-VFD (control). (b) MWCNTs processed at 0.5 mg/mL. (c) 0.25 mg/mL. (d) 0.1 mg/mL. (e) 0.1 mg/mL processed through two cycles with laser-VFD processing. For AFM imaging, as-prepared samples were directly drop-casted on silicon wafers without centrifugation post VFD processing;

FIG. 18 shows the results of Raman mapping for Cdots processed using two cycles of continuous flow VFD (0.1 mg/mL, flow rate of 0.45 mL/min, 7500 rpm) under pulsed laser irradiation (1064 nm, 450 mJ) at 45° tilt. (a) AFM images of the mapped area and corresponding zoomed-in images. (b) Optical image and Raman maps of the highlighted area (square) with the two map images representing the D (1352 cm⁻¹) and G (1594 cm⁻¹) bands of graphitic material. (c) Three representative single spectrum correspond to the three circled spot in b. Scanned area was 20×20 μm²;

FIG. 19 shows images of Cdots fabricated under optimized conditions (two cycles continuous flow, 0.1 mg/mL, flow rate of 0.45 mL/min, 7500 rpm, 450 mJ, at 45° tilt). (a) AFM image and height distributions based on >300 individual Cdots (inset). (b) SEM image. (c) TEM, selected area electron diffraction pattern (inset) and HRTEM images. (d) XRD results of as received MWCNTs and as-processed Cdots;

FIG. 20 shows: (a) UV-vis spectrum of Cdots prepared according to an embodiment of the present disclosure. (b) C is spectrum of Cdots prepared according to an embodiment of the present disclosure. (c) FT-IR spectra of Cdots prepared according to an embodiment of the present disclosure;

FIG. 21 shows: (a) Contour fluorescence map for excitation and emission of the Cdots (from the optimized condition). The black dot represents the maximal fluorescence intensity of the Cdots, received at an excitation wavelength of 345 nm and at an emission 450 nm. (b) Fluorescence microscopy excited at 365 nm. (c) PL spectra of the Cdots. Two emission peaks at constant wavelength of 435 and 466 nm were for different excitation wavelengths, from 277 to 355 nm. (d) Fluorescence decays of Cdots excited at 377 nm. (e) Decaying lifetime of three emissive sites;

FIG. 22 shows a schematic of laser-VFD processing for fabricating Cdots from MWCNTs. The black dots above and below the ball-and-stick model of the Cdots highlight the sample may contain different layers of graphene;

FIG. 23 shows AFM height images (a) as received BNNTs, (b) sliced BNNT, (c) kinked region as an effect of shear and the pulsed laser, and (d) magnified image of the kinked region;

FIG. 24 shows AFM height images of sliced BNNTs;

FIG. 25 shows formation of precipitates post laser-VFD of O-MWCNT dispersed in water at 0.02 mg/mL;

FIG. 26 shows Raman spectroscopy of (a) oxidised SWCNTs (O-SWCNTs) and (b) laser VFD processed O-SWCNTs, and (c) the ratio of the intensity of D band to G band of the O-SWCNTs (control) and laser VFD processed O-SWCNTs showing a decrease in defect density after processing;

FIG. 27 shows SEM images of the fullerene C₆₀ flowerlike microcrystals formed in a solution of toluene under shear in the VFD at different concentrations and rotational speeds; (a 0.1 mg/mL at 5000 rpm, (d-f) 0.1 mg/mL at 8000 rpm, and (g-h) 0.05 mg/mL at 5000 rpm;

FIG. 28 shows a schematic summary of the procedure for preparing particles of self-assembled C60 under shear in the VFD, for toluene and o-xylene, which is also applicable to the other solvents;

FIG. 29 shows a schematic of VFD processing for confined and continuous flow modes of operation of the device (top insets);

FIG. 30 shows SEM images of C₆₀ particles formed in toluene (0.05 mg/mL) for the VFD operating in the CM at 4 krpm (a) and 7.5 krpm (b), and θ=45°;

FIG. 31 shows (a-f) SEM images of stellated C₆₀ obtained from VFD processing of a 0.1 mg/mL solution of C₆₀/toluene under the optimal condition, 4 krpm, 0.1 mL/min and θ=45°;

FIG. 32 shows SEM images of C₆₀ rods obtained from a toluene solution of C₆₀ solution with the tube rotating at 7 krpm, concentration 0.1 mg/mL, flow rate 1 mL/min and θ=45°;

FIG. 33 shows SEM images, at different magnifications, of C₆₀ spherical-like particles formed in a solution of 0.1 mg/mL C₆₀ in o-xylene with the VFD tube rotating at 4 krpm, a flow rate of 1 mL/min and θ=45°;

FIG. 34 shows AFM images at different magnifications of spherical-like particles of C₆₀ formed from 0.1 mg/mL of C₆₀ in o-xylene with the tube rotating at 4 krpm, and a flow rate of 1 mL/min and θ=45°;

FIG. 35 shows SEM images of C₆₀ spherical-like particles formed at different concentration, 0.2, 0.1 and 0.025 mg/mL of C₆₀ in o-xylene, with the VFD operating at 4 krpm, with a flow rate of 1 mL/min and θ=45°;

FIG. 36 shows UV-visible spectra of C₆₀ in toluene post-VFD processing, for different (a) speeds, (b) tilt angles and (c) flow rates;

FIG. 37 shows Raman spectra (a) and (b) XRD patterns of C₆₀ stellated (middle) and spherical (top) particles, and as received C₆₀;

FIG. 38 shows SEM images of C₆₀ particles generated in the VFD in different solvents: m-xylene, 4 krpm (a); p-xylene 4 krpm (b); p-xylene 5 krpm (c); mesitylene 4 krpm (d); and composite particles generated from a mixing of C₆₀ and C₇₀ (1:1) in mesitylene, 7.5 krpm, and 4 krpm (e and f), respectively. A flow rate fixed at 0.5 mL/min;

FIG. 39 shows SEM images of the different morphologies of C₇₀ crystals fabricated in the presence of different aromatic solvents; mesitylene, ortho-xylene and toluene; and

FIG. 40 shows time dependent phase transition of C70 flow like particles formed in toluene.

### DESCRIPTION OF EMBODIMENTS

As used herein, and unless expressly stated otherwise, the following abbreviations used throughout this specification have the following meanings:
CNTs: carbon nanotubes
SWCNTs: single walled carbon nanotubes
DWCNTs: double walled carbon nanotubes
MWCNTs: multi walled carbon nanotubes
Cdots: carbon nanodots
VFD: vortex fluidic device.

We previously developed a method for laterally slicing CNTs (single, double and multi walled) in the presence of a benign solvent system, N-methyl pyrollidinone (NMP) and water¹². The processing method involved controlling mechanoenergy generated within dynamic thin films in a vortex fluidic device (VFD) and a simultaneous pulsed laser operating at 1064 nm wavelength. The conditions for the effective slicing of the CNTs was optimized by varying a number of control parameters (but not extensively), including concentration of the CNT dispersion, time of exposure to both the intense shear and irradiation from the pulsed laser, dependently and independently, flow rates under the continuous flow operation, changing the wavelength of the pulsed laser (to 532 nm), varying the laser power, and changing the rotational speeds and inclination angles of the tube in the VFD. This was to obtain sufficient shear to bend the CNTs and sufficient laser power to cleave C—C bonds, which occurs during the slicing process. Shear forces created in the VFD resulted in local bending of the CNTs, as established by the observation that toroidal arrays of SWCNTs were produced in a mixture of toluene and water in the VFD in the absence of laser irradiation¹³. Bending is not surprising given the very high aspect ratio for SWCNTs and the departure from laminar flow in the thin film in the VFD, and with the high C—C vibrational energy imparted by the laser, bond rupture prevails. To explore this further in understanding the mechanism of slicing, molecular dynamics simulations were carried out for SWCNTs, with hairpin-shaped tubes created to mimic the bending occurring in the VFD. When relaxed near room temperature, the hairpin unfolds and no defects are created. However, when the system is raised to a high temperature (i.e. mimicking the laser irradiation) a large tear occurs in the bent region and other defects appear nearby. The tear (damage) arising from the imparted high vibrational energy (equivalent to heating to high temperatures) occurs for bonds that are already strained. These observations explain the experimental result that slicing occurs in the VFD only under laser irradiation, and that slicing does not occur in batch processing in the presence of such a laser. Without the shear forces provided by the VFD, there is no or limited localized bending or strained bonds. These initial studies produced sliced carbon nanotubes without the ability to control the length and size distribution. Further research has established a number of important control aspects of manipulating CNTs in the VFD.

The reactor used in the processes described herein is a vortex fluidic device (VFD). Details of the VFD are described in published United States patent application US 2013/0289282, the details of which are incorporated herein by reference. Briefly, the thin film tube reactor comprises a tube rotatable about its longitudinal axis by a motor. The tube is substantially cylindrical or comprises a portion that is tapered. The motor can be a variable speed motor for varying the rotational speed of the tube and can be operated in controlled set frequency and set change in speed. A generally cylindrical tube is particularly suitable but it is contemplated that the tube could also take other forms and could, for example, be a tapered tube, a stepped tube comprising a number of sections of different diameter, and the like. The tube can be made of any suitable material including glass, metal, plastic, ceramic, and the like. In certain embodiments, the tube is made from borosilicate. Optionally, the inner surface of the tube can comprise surface structures or aberrations. In embodiments, the tube is a pristine borosilicate NMR glass tube which has an internal diameter typically 17.7±0.013 mm.

The tube is situated on an angle of incline relative to the horizontal of above 0 degrees and less than 90 degrees. In certain embodiments, the tube is situated on an angle of incline relative to the horizontal of between 10 degrees and 90 degrees. The angle of incline can be varied. In embodiments the angle of incline is 45 degrees. For the majority of the processes described herein, the angle of incline has been optimized to be 45 degrees relative to the horizontal position, which corresponds to the maximum cross vector of centrifugal force in the tube and gravity. However, other angles of incline can be used including, but not limited to, 1 degree, 2 degrees, 3 degrees, 4 degrees, 5 degrees, 6 degrees, 7 degrees, 8 degrees, 9 degrees, 10 degrees, 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees, 26 degrees, 27 degrees, 28 degrees, 29 degrees, 30 degrees, 31 degrees, 32 degrees, 33 degrees, 34 degrees, 35 degrees, 36 degrees, 37 degrees, 38 degrees, 39 degrees, 40 degrees, 41 degrees, 42 degrees, 43 degrees, 44 degrees, 46 degrees, 47 degrees, 48 degrees, 49 degrees, 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees, 71 degrees, 72 degrees, 73 degrees, 74 degrees, 75 degrees, 76 degrees, 77 degrees, 78 degrees, 79 degrees, 80 degrees, 81 degrees, 82 degrees, 83 degrees, 84 degrees, 85 degrees, 86 degrees, 87 degrees, 88 degrees, and 89 degrees. If necessary, the angle of incline can be adjusted so as to adjust the location of the vortex that forms in the rotating tube relative to the closed end of the tube. Optionally, the angle of incline of tube can be varied in a time-dependent way during operation for dynamic adjustment of the location and shape of the vortex.

A spinning guide or a second set of bearings assists in maintaining the angle of incline and a substantially consistent rotation around the longitudinal axis of the tube. The tube may be rotated at rotational speeds of from about 2000 rpm to about 9000 rpm.

The thin film tube reactor can be operated in a confined mode of operation for a finite amount of liquid in the tube or under a continuous flow operation whereby jet feeds are set to deliver reactant fluids into the rapidly rotating tube, depending on the flow rate. Reactant fluids are supplied to the inner surface of the tube by way of at least one feed tube. Any suitable pump can be used to pump the reactant fluid from a reactant fluid source to the feed tube(s).

A collector may be positioned substantially adjacent to the opening of the tube and can be used to collect product exiting the tube. Fluid product exiting the tube may migrate under centrifugal force to the wall of the collector where it can exit through a product outlet.

Controlling the length of CNTs within nanoscale dimensions offers a new pathway towards uptake for length specific applications. Depending on the growth process, CNTs are typically grown millimetres in length, which poses a number of challenges for processing within liquid media. These problems are often due to the low dispersibility in most organic solvents and the strong aggregation between the strands which makes them quite challenging to process, to exploit and to enhance their properties. Another key challenge is obtaining control over the lengths of the CNTs. There have been a number of attempts reported on such control, but they require the use of concentrated acids, the addition of stabilising agents, high temperature processing and lengthy processing times.

Debundled, short SWCNTs show great potential in a variety of applications, such as for drug delivery⁶, including the incorporation in lipid bilayers for sensing⁷, to increase the efficiency of solar cells¹⁰ and others. For example, short length CNTs enhance the efficiency of electronic devices^{8,9}. Shorter CNTs provide efficient hole transportation having a few nm transportation path while maintaining high conductivity. Moreover, bundled long stranded tubes have raised concerns within the biological arena, with increasing toxicity levels in proportion with the length of the nanotubes. Shorter length CNTs within a narrow length distribution have more potential for biological applications^{14,15}. For example, the use of CNTs with a large length range distribution, 200 to 1000 nm was observed to clog the bloodstream in vivo. Short CNTs within a narrow length distribution, approximately 50 to 300 nm is an ideal length as drug carriers in treating the Alzheimer's disease¹⁶.

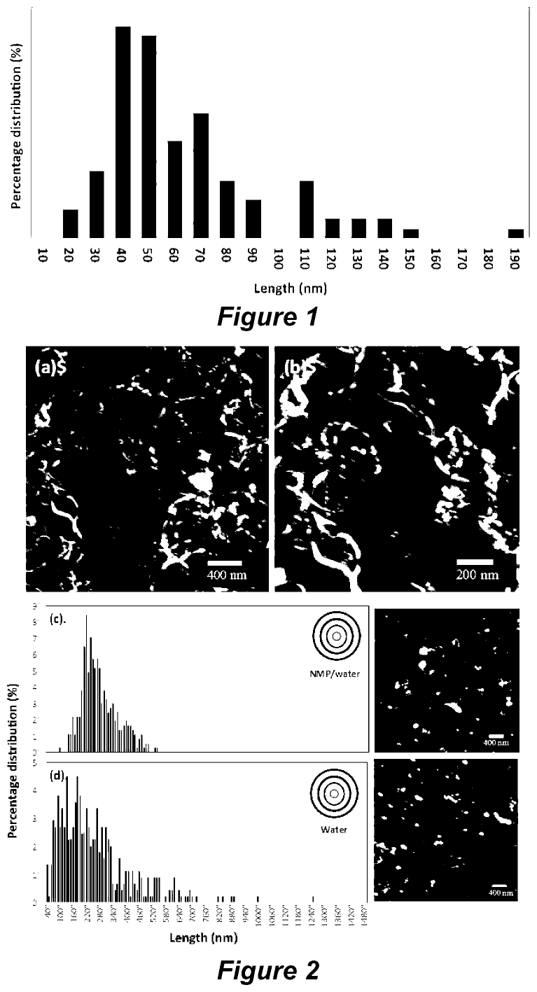

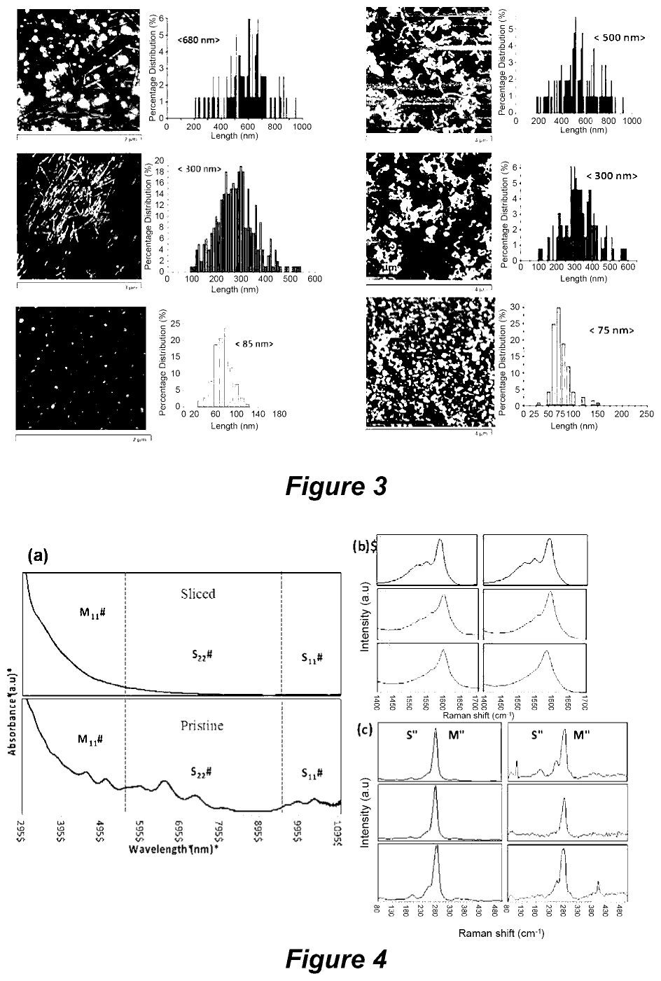

With the understanding from molecular dynamic simulations of the mechanism of slicing, shear forces in the VFD cause localised bending and strained bonds with a simultaneous pulse laser providing sufficient energy to rupture the strained C—C bonds, affording sliced nanotubes within a particular length distribution¹². Thus, controlling the length of the CNTs requires a method to control the extent of localised bending of the CNTs and energy input from the laser. The amount of laser power required to rupture the strained bonds is dependent on the extent of localised bending. We systematically studied the controlled bending of CNTs by altering the rotational speed of the VFD, along with varying the laser power; combining the two inputs allows one to control the length of sliced CNTs. Our results show that lower shear rates in the VFD (rotational speed 6500 rpm) and higher laser power (600 mJ) under the continuous flow mode of operation affords sliced nanotubes with much shorter lengths, with an average of 40-50 nm (FIG. 1).

Thus, according to a first aspect there is provided a process for producing a carbon nanotube product comprising predominantly carbon nanotube (CNTs) having a desired average length. The process comprises providing a composition comprising starting CNTs. The composition comprising starting CNTs is introduced to a thin film tube reactor comprising a tube having a longitudinal axis, wherein the angle of the longitudinal axis relative to the horizontal is between about 0 degrees and about 90 degrees. The tube is rotated about the longitudinal axis at a predetermined rotational speed and the CNT composition in the thin film tube reactor is exposed to laser energy at a predetermined energy dose. The carbon nanotube product comprising predominantly CNTs having a desired average length is then recovered from the thin film tube reactor. The predetermined rotational speed is from about 6000 rpm to about 7500 rpm, the predetermined energy dose is from about 200 mJ to about 600 mJ and the values of the predetermined rotational speed and the predetermined energy dose are selected to produce SWCNTs having an average length of from about 50 nm to about 700 nm.

In certain embodiments of the first aspect, the angle of the longitudinal axis relative to the horizontal is about 45 degrees.

In certain embodiments, the CNTs having a desired average length have an average length of 40-50 nm, 75 nm, 85 nm, 150 nm, 200 nm, 300 nm, 500 nm or 680 nm. Notably, the distribution of the average length of CNTs formed according to the process of the first aspect is narrower than the distribution of the average length of CNTs formed in earlier published work¹². Furthermore, in the earlier work¹² the average length of the CNTs formed was ˜160-170 nm.

The composition of starting CNTs comprises a solvent or liquid phase. In certain embodiments, the solvent or liquid phase comprises water. In certain other embodiments, the solvent or liquid phase comprises a mixture of water and a solvent. In certain other embodiments, the solution of starting CNTs comprises a solvent. Suitable solvents include dipolar aprotic solvents and protic solvents. Examples of suitable solvents include, but are not limited to: N-methyl-2-pyrollidone (NMP), tetrahydrofuran, ethers, alcohols, ionic liquids, eutectic melts, and supercritical solvents.

The composition of starting CNTs may be in the form of a solution, dispersion, suspension or emulsion.

Advantageously, the composition of the composition of starting CNTs can be selected to determine the average length of the CNTs formed. For example, CNTs having an average length of 220 nm can be formed at a predetermined rotational speed of 7500 rpm, a predetermined energy dose of 260 mJ and a solution of starting CNTs comprising NMP and water in a 1:1 ratio, whilst CNTs having an average length of 150 nm can be formed at a predetermined rotational speed of 7500 rpm, a predetermined energy dose of 260 mJ and a composition of starting CNTs consisting essentially of water.

In certain embodiments, the starting CNTs are pre-treated prior to formation of the composition of starting CNTs. For example, the starting CNTs may be oxidised prior to formation of the composition of starting CNTs. The starting CNTs may be oxidised using an oxidant. The oxidant may be selected from the group consisting of: peroxides capable of producing hydroxyl radicals, such as hydrogen peroxide; singlet oxygen generated in situ or otherwise; organic peroxides; bleach materials and the like; and reactive species from an oxygen plasma generated in situ in the VFD. Oxidation may be used to increase the solubility of the starting CNTs in the solvent or liquid phase used in the composition comprising starting CNTs.

In certain embodiments, the predetermined rotational speed is 6500 rpm and the predetermined energy dose is about 600 mJ.

In certain embodiments, the composition of starting CNTs is introduced to the thin film tube reactor in a continuous flow.

In certain embodiments, the composition of starting CNTs is introduced to the thin film tube reactor as batch of fixed volume.

In certain embodiments, the CNTs are single wall carbon nanotubes (SWCNTs). In certain other embodiments, the CNTs are multi walled carbon nanotubes (MWCNTs).

To control the lengths of the CNTs, pristine (as received) CNTs were functionalised using a previously published method¹⁷. The CNTs were dispersed in two different solvent systems, (a) NMP/water and (b) water. The oxidised CNTs were then treated under intensive shear within the VFD in the presence of a pulsed laser operating at 1064 nm wavelength at 260 mJ to afford narrow length distributions of short CNTs, with average lengths of approximately 220 nm and 150 nm respectively, with a much narrower distribution in comparison to the initial published work¹² (FIG. 2). This is for both water as a solvent and water:NMP (1:1) as a solvent. The fact that different length CNTs are produced in each solvent means that varying the ratio of solvent (e.g. NMP and water) can be used to control and vary the lengths of the CNTs.

An alternative route to control the lateral slicing of CNTs (single, double and multi-walled) is to use a pulsed laser of more than one wavelength, i.e. 532 nm wavelength or a continuous laser of other light sources. This allows systematically controlling the length of the laterally sliced CNTs. The method involves controlling the amount of power required from combined simultaneous 1064 nm and 532 nm wavelength lasers to precisely afford CNTs of specific length upon bending under intense shear. Suitable conditions include a combined laser power of 368 mJ (260 mJ from the 1064 nm wavelength and 108 mJ from the 532 nm wavelength) under optimised conditions in the VFD (i.e. a tilt angle of 45° and a rotational speed of 7500 rpm) to afford sliced CNTs with an average length of approximately 300 nm. The optimisation of the laser power from lasers of more than one wavelength offers an alternative route to control the length of the sliced CNTs.

CNTs subjected to the shear forces created in the VFD resulted in localized bending and strained bonds which then combined with heating from the laser at the point of bending resulted in rupture of the C—C bonds. Thus, the understanding of this mechanism led to the development of a method to control the lengths of CNTs down to ca 600 nm, 300 nm and 80 nm by changing the rotational speed of the VFD and the amount of laser power used to cleave the C—C bonds. These lengths are deemed important for specific applications such as in electronic devices and drug delivery applications.

A single wall carbon nanotube (SWCNT) can be thought of as a cylindrical structure formed by rolling up a graphene sheet. The electronic and optical properties of SWCNTs are dependent on the direction and magnitude of the rolling vector, being either semiconducting (s) or metallic (m) depending on the chiral angle and the diameter of the tube¹⁹. The energy bandgap of semiconducting CNTs are inversely proportional to the nanotube diameter. Many advanced applications require high purity CNTs with well-defined structures and electrical properties. For example, the semiconducting configuration is required for nanoscale field-effect transistors while the metallic configurations are used in nanoscale circuits. With the various current methods of growth consisting of a complex mixture of both the semiconducting and metallic chiralities, there is a need to separate or convert (interconvert) them, to manipulate their properties accordingly.

To avoid the need for surfactants and other chromatographic methods of separation that are low yielding and high costs, we developed a simple and novel method to enrich sliced CNTs into the metallic and semiconducting configuration. Specifically, according to a second aspect, there is provided a process for producing a single walled carbon nanotube product comprising single walled carbon nanotubes (SWCNTs) enriched in either a metallic chirality or a semiconducting chirality. The process comprises providing a composition comprising starting SWCNTs having metallic and semiconducting chiralities. The composition comprising starting SWCNTs having metallic and semiconducting chiralities is introduced to a thin film tube reactor comprising a tube having a longitudinal axis, wherein the angle of the longitudinal axis relative to the horizontal is between about 0 degrees and about 90 degrees. The tube is rotated about the longitudinal axis at a rotational speed, the composition comprising starting SWCNTs having metallic and semiconducting chiralities is exposed to an energy source and the tube is maintained at the rotational speed and the aqueous solution of SWCNTs is exposed to energy from the energy source for a time sufficient to produce the single walled carbon nanotube product comprising SWCNTs enriched in either a metallic chirality or a semiconducting chirality.

In certain embodiments of the second aspect, the angle of the longitudinal axis relative to the horizontal is about 45 degrees.

In certain embodiments of the second aspect, the rotational speed is 7500 rpm.

In certain embodiments of the second aspect, the energy source is a light source. The light source may be a laser, such as a Nd:YAG laser. The laser may operate at a wavelength of 1064 nm at a laser power of about 260 mJ.

In certain embodiments of the second aspect, the composition comprising starting SWCNTs comprises a mixture of water and a solvent. Suitable solvents include dipolar aprotic solvents and protic solvents. Examples of suitable solvents include, but are not limited to: N-methyl-2-pyrollidone (NMP), tetrahydrofuran, an ether, an alcohol, an ionic liquid, a eutectic melt, and a supercritical solvent.

In certain embodiments of the second aspect, the composition comprising starting SWCNTs is introduced to the thin film tube reactor in a continuous flow.

In certain embodiments of the second aspect, the composition comprising starting SWCNTs is introduced to the thin film tube reactor as batch of fixed volume.

In certain embodiments of the second aspect, the nanotube product comprises single walled carbon nanotubes (SWCNTs) enriched in metallic chirality. In certain of these embodiments, the light energy is provided by a pulsed Nd:YAG laser. In certain of these embodiments, the light energy provided by the laser is about 260 mJ.

In certain embodiments of the second aspect, the nanotube product comprises single walled carbon nanotubes (SWCNTs) enriched in semiconducting chirality. In certain of these embodiments, the light energy is provided by one or more circular polarised pulsed laser sources.

In certain embodiments of the second aspect, the method is used to generate optically pure SWCNTs of a specific (n,m).

Specifically, under both confined mode and continuous flow operations, as received SWCNTs comprising of a mixture of semiconducting and metallic chiralities are sliced in a mixture of NMP/water at a 1:1 ratio in the presence of shear in the VFD to bend the high tensile strength SWCNTs and a pulsed Nd:YAG laser to break the strained C—C bonds. The ballistic wave from the pulsed laser at 260 mJ laser power overcomes the large barrier of energy, changing the magnitude and rolling vector of the semiconducting nanotubes affording the metallic configuration. FIG. 4(a) depicts the optical absorption spectra of the separated SWCNT fraction after one pass under the continuous flow operation of the VFD, with the disappearance of the S₁₁ peaks and a prominent M₁₁ peak. It is noteworthy that the separated fraction still contains a small fraction of the SWCNTs of the S₂₂ configuration which can then be separated through a second pass in the VFD under continuous flow^{18,20}. FIG. 4(b) depicts the Raman analysis, a comparison of the G band regions, of the as received SWCNTs and the separated metallic SWCNTs. For both semiconducting and metallic configurations, there are characteristic differences between the G bands, with two dominant features between 1500 and 1600 cm⁻¹ corresponding to the vibrations along the circumferential direction (ω_{G}) and a high frequency component attributed to vibrations along the direction of the nanotube axis (ω_{G+})²¹. The as received SWCNTs show both the ω_{G-} and ω_{G+} peaks in a Lorenzian lineshape with the ω_{G+} being stronger in intensity compared to the ω_{G-} peak. Upon slicing, both of the peaks merge and become much broader, exhibiting an asymmetric Breit-Wigner-Fano lineshape, which is in agreement with the presence of enriched metallic nanotubes in the sample. The frequency of the radial breathing mode (RBM) is proportional to the inverse diameter of the CNTs, with the diameter and the chiral angle used to define the (n,m) integers of the CNTs. All metallic SWCNTs have RBM frequencies in the range between 200-280 cm⁻¹ while the semiconducting SWCNTs range between 160-200 cm⁻¹. The RBM peaks of the sliced SWCNTs were analyzed and the peaks corresponding to the semiconducting CNTs (˜186 cm¹) disappear with an additional prominent metallic peak (˜248 cm⁻¹) observed²¹.

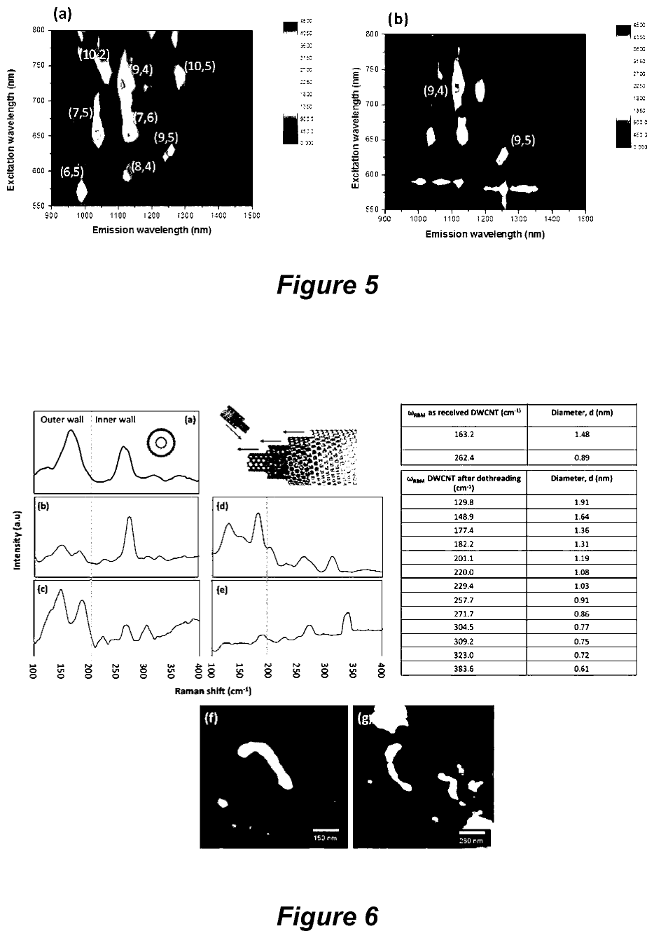

The sliced SWCNT sample was also characterized using photoluminescence (PL) contours (FIG. 5). The results indicated that although there was evidence that the sliced SWCNT sample were enriched with the metallic configuration (optical absorbance and Raman analysis), the PL contour plots established that the process resulted in enhancement of the adsorption of the (9,4) chirality specifically, with the other semiconducting chiralities losing their adsorbability and diminishing within the sample. These results were observed just after a single pass in the VFD under continuous flow in the presence of a pulsed laser at ˜260 mJ. This demonstrates the ballistic pulses from the pulsed laser at 260 mJ laser power overcome the large barrier of energy for interconverting different configurations of SWCNTs. This process is effectively changing the magnitude and rolling vector of the semiconducting nanotubes affording SWCNTs enriched with metallic characteristics with a specific semiconducting chirality still present.

It is expected that the use of circular polarised pulsed laser sources, or other light sources, can be used to convert/interconvert SWCNTs of different chiralities, and indeed may be effective in generating optically pure SWCNTs of a specific (n,m).

Dethreading of multiwalled carbon nanotubes involves the spontaneous removal of the inner shells to gain access to single walled carbon nanotubes of progressively larger diameters. According to a third aspect, there is provided a process for dethreading double walled carbon nanotubes (DWCNTs) and/or multi walled carbon nanotubes (MWCNTs) to produce single walled carbon nanotubes (SWCNTs) therefrom. The process comprises providing a composition comprising DWCNTs and/or MWCNTs, a liquid phase and a surfactant. The composition is introduced to a thin film tube reactor comprising a tube having a longitudinal axis, wherein the angle of the longitudinal axis relative to the horizontal is between about 0 degrees and about 90 degrees. The tube is rotated about the longitudinal axis at a rotational speed and the composition is exposed in the thin film tube reactor to light energy. The tube is maintained at the rotational speed and the composition is exposed to the light energy for a time sufficient to produce SWCNTs.

In certain embodiments of the third aspect, the angle of the longitudinal axis relative to the horizontal is about 45 degrees.

In certain embodiments of the third aspect, the rotational speed is 7500 rpm.

In certain embodiments of the third aspect, the liquid phase comprises water.

In certain embodiments of the third aspect, the surfactant is a relatively large hydrophobic surfactant. In certain of these embodiments, the surfactant is p-phosphonated calix[n]arene, where n=4, 5, 6, and 8, but other surfactants are envisaged, including for example, and related p-sulfonated calix[n]arenes, where n=4, 5, 6 and 8, and general classes of surfactants such as dodecyl sulfate and the like, and polymer and co-polymers, including natural polymers (such as peptides and DNA) and synthetic polymers such as polyethylene glycol and the like. In specific embodiments, the surfactant is p-phosphonated calix[n]arene, where n=8.

In certain embodiments of the third aspect, the composition is introduced to the thin film tube reactor in a continuous flow.

In certain embodiments of the third aspect, the composition is introduced to the thin film tube reactor as batch of fixed volume.

In certain embodiments of the third aspect, the light energy is provided by a pulsed Nd:YAG laser. In certain of these embodiments, the light energy provided by the laser is about 260 mJ.

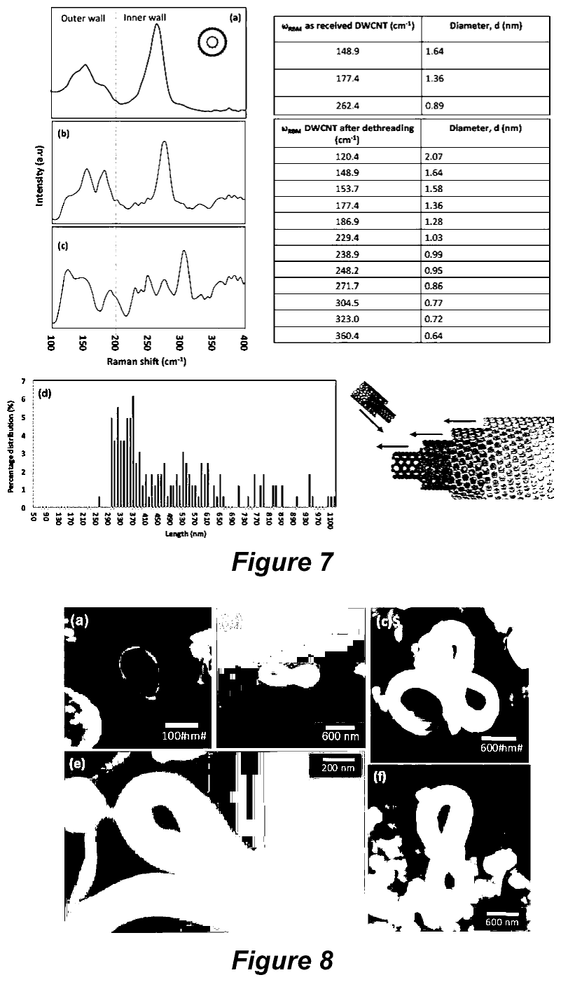

In certain embodiments of the third aspect, the process is used to control the length of DWCNTs within a length range of approximately 300-400 nm with and without dethreading. Dethreading of the DWCNTs and MWCNTs is possible during in situ slicing in the presence of shear in the VFD, coupled with a pulsed laser, and a surfactant, or post VFD processing (FIGS. 6 and 7). Spontaneous removal of the inner shells was observed from the sliced sample of multiwalled CNTs. The large hydrophobic surfactant, p-phosphonated calix[8]arene was employed to further facilitate the dethreading (and maintain colloidal stability) of the multi walled CNTs. The method involves slicing in water in the presence of the calixarene, which avoids the use of an organic solvent. Single walled CNTs of large diameters have potential in medical applications, specifically for increased drug loading capacity, and the size of the moieties to be included, for example large proteins. The method established a novel route to dethread and slice CNTs of multiple shells in the presence of a benign solvent system. This method offers an alternative route towards controlling the length of DWCNTs within a length range of approximately 300-400 nm with and without dethreading.

We note (i) that reducing the length of CNTs (see above), and removal of defects, which essentially straightens them, will facilitate movement of the concentric layers of SWCNTs in the DWCNTs and MWCNTs relative to each other, (ii) this affords longer CNTs, as a further example of controlling the length.

We have also found that the VFD is effective in debundling and overcome the high flexural rigidity of the CNTs to form tightly coiled toroidal structures¹³. Thus, according to a fourth aspect there is provided a process for forming toroidal carbon nanoforms from single walled carbon nanotubes (SWCNTs). The process comprises providing a water/hydrocarbon solvent dispersion of SWCNTs and introducing the dispersion to a thin film tube reactor comprising a tube having a longitudinal axis, wherein the angle of the longitudinal axis relative to the horizontal is between about 0 degrees and about 90 degrees. The tube is rotated about the longitudinal axis at a rotational speed and in a rotational direction under conditions to form toroidal carbon nanoforms from the SWCNTs.

In certain embodiments of the fourth aspect, the angle of the longitudinal axis relative to the horizontal is about 45 degrees.

In certain embodiments of the fourth aspect, the hydrocarbon solvent is selected from the group consisting of: an aromatic solvent such as toluene, o-xylene, m-xylene, p-xylene or mesitylene; an aliphatic hydrocarbon such as pentane, hexane, etc; and water immiscible liquid hydrocarbon materials such as natural oils (e.g. canola oil) and synthetic oils (e.g. biodiesel and the like).

In certain embodiments of the fourth aspect, the toroidal carbon nanoforms are in the form of figure of 8 nanoforms, the chirality of which is controlled using the rotational direction.

In certain embodiments of the fourth aspect, the rotational speed is about 7500 rpm. In these embodiments, the reaction time may be about 30 minutes.

In certain embodiments of the fourth aspect, the diameters of the rings of the figure of 8 nanoforms produced are within the range of from about 300 to about 700 nm, or from about 100 nm to about 200 nm.

We have found that the shear stress generated in the VFD provides sufficient energy to bend the CNTs to the extent where the ends come in contact and spontaneously fuse under high mechanical energy in the VFD. In addition, for long processing times, chiral “figure of 8” structures can be formed with an excess of one chirality, due to the direction of the fluid flow in the VFD under the confined mode of operation. Changing the direction of rotation during the synthesis of the “figure of 8” will change the dominance of one chirality over the other for the “figure of “8”. Passing solutions back through the VFD may further increase the enantiomeric excess of one chiral figure of 8 over another, with reversing the direction of rotation likely to reverse the chirality of the enantiomer in excess.

Cdots are carbon nanoparticles with dimensions of <10 nm in size consisting of a graphitic structure or amorphous carbon core and carbonaceous surfaces, with the basal places rich in oxygen-containing groups²². Similar to other carbon nanomaterials, Cdots exhibit exceptional properties in particular the strong quantum confinement and edge effects resulting in exceptional fluorescent properties²³. A number of methods have been reported but with significant limitations affording Cdots without uniformity in shape, size and morphology²⁴. These include using chemical ablation²⁴, electrochemical carbonisation²⁵, laser ablation²⁶, arc-discharge²⁷, ultrasound and microwave-assisted pyrolysis²⁸, which afford Cdots in low yield and with low photoluminescence efficiency.

We developed a method using a Nd:YAG laser at a 1064 nm wavelength in the presence of different organic solvents to fabricate fluorescent carbon nanoparticles from graphite powder. The method afforded carbon nanoparticles using laser irradiation coupled with high energy sonication of a wide diameter range between 1-8 nm²⁹. Thus, according to a fifth aspect there is provided a process for fabricating carbon nanodots. The process comprises providing or forming an aqueous composition comprising oxidised MWCNTs and introducing the aqueous composition to a thin film tube reactor comprising a tube having a longitudinal axis, wherein the angle of the longitudinal axis relative to the horizontal is between about 0 degrees and about 90 degrees. The tube is rotated about the longitudinal axis at a rotational speed and the aqueous composition in the thin film tube reactor is exposed to light energy. The tube is maintained at the rotational speed and the aqueous composition exposed to the light energy for a time sufficient to produce carbon nanodots.

In certain embodiments of the fifth aspect, the angle of the longitudinal axis relative to the horizontal is about 45 degrees.

In certain embodiments of the fifth aspect, the light energy is provided by a laser. In certain embodiments, the laser operates at 1064 nm, 532 nm, 266 nm, and combinations thereof. In certain embodiments, the laser is a pulsed laser. In certain embodiments, the laser operates at a power of about 260 mJ. In certain other embodiments, the laser operates at a power of about 450 mJ.

In certain embodiments of the fifth aspect, the rotational speed is about 7500 rpm.

In certain embodiments of the fifth aspect, the concentration of MWCNTs in the aqueous composition comprising oxidised MWCNTs is about 0.1 mg/mL.

In certain embodiments of the fifth aspect, the carbon nanodots produced are relatively uniform in shape and size.

In certain embodiments of the fifth aspect, the oxidised MWCNTs are formed in situ by introducing an aqueous composition comprising MWCNTs and an oxidant capable of oxidising MWCNTs to the thin film tube reactor. The oxidant may be selected from the group consisting of: peroxides capable of producing hydroxyl radicals, such as hydrogen peroxide; singlet oxygen generated in situ or otherwise; organic peroxides; bleach materials and the like; and reactive species from an oxygen plasma generated in situ in the VFD. In certain embodiments, the carbon nanodots produced have a size of about 6 nm.

In certain embodiments of the fifth aspect, the process further comprises centrifuging the reaction product mixture and separating solid product comprising carbon nanodots from the supernatant.

In certain other embodiments of the fifth aspect, the aqueous composition comprising oxidised MWCNTs is formed by dispersing oxidized MWCNTs in a mixture of water and a solvent. Suitable solvents include dipolar aprotic solvents and protic solvents. Examples of suitable solvents include, but are not limited to: N-methyl-2-pyrollidone (NMP), tetrahydrofuran, ethers, alcohols, ionic liquids, eutectic melts, and supercritical solvents.

In certain embodiments of the fifth aspect, the carbon nanodots produced have a size of less than about 4 nm, such as about 2 nm.

The newly developed process overcomes the drawbacks of conventional processing methods, to fabricate Cdots in high yield with uniformity in the shape and size, of about 6 nm. The Cdots are fabricated by debundling and disintegrating MWCNTs (or other forms of carbon) in the presence of hydrogen peroxide (30% in water), in the presence of intensive shear and a pulsed laser operating at 1064 nm (but not limited to this wavelength or the use of pulse irradiation). Aqueous H₂O₂ was chosen due to high amounts of hydroxyl free radicals produced in the presence of an irradiation from a pulsed laser³⁰. The laser irradiation absorbs the photons, which then break down H₂O₂ into water molecules and extremely reactive radicals of oxygen. The free oxygen radicals then chemically attack CNTs, like in large organic-pigmented molecules with double bonds and long carbon chains broken into small ones via rapid oxidation¹⁴.

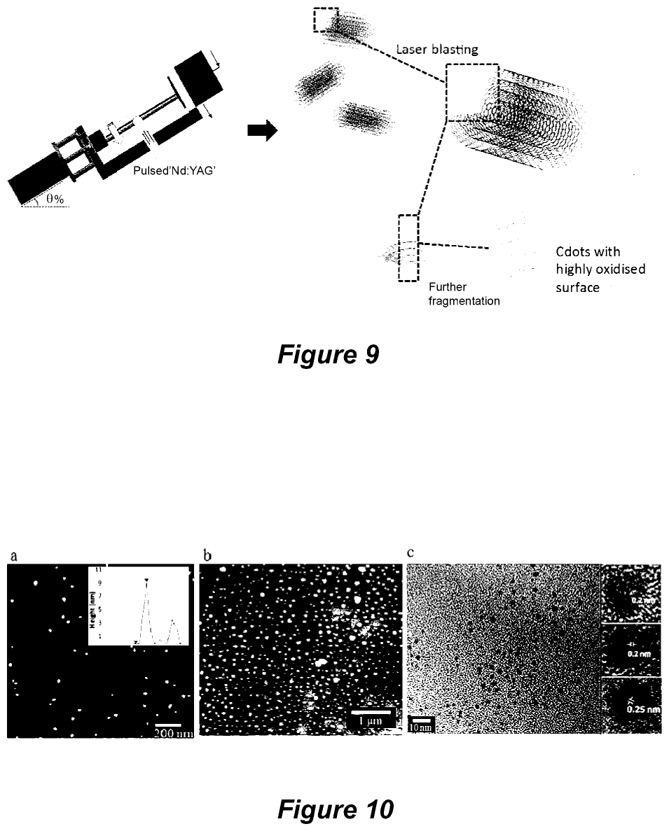

MWCNTs were purchased from Sigma Aldrich, prepared using the chemical vapour deposition method with an as-received purity >98%. MWCNTs (10 mg) was dispersed in 60 mL of 30% H₂O₂ (˜0.2 mg/mL), following ultrasonication (˜5 minutes) to afford a stable black dispersion. Under the continuous flow mode of operation, the MWCNT dispersion was introduced into the rapidly rotating tube at a flow rate of 1 mL/min using conditions of θ 45° and a rotational speed of 7500 rpm with a simultaneously nanosecond pulsed laser at 1064 nm (pulsed Q-switch Nd:YAG laser) operating at a power of ca 260 mJ (FIG. 9). Centrifugation of the clear dispersion collected (1180×g) for 30 minutes was used to remove bundled long MWCNTs and any impurities still present in the sample. The pellet containing the Cdots was washed multiple times with Milli-Q water. The washed Cdots were then dispersed in Milli-Q water and ultracentrifuged (11200×g) for 30 min. The Cdots with a yield of ˜62% were recovered for characterization purposes using SEM, AFM, Raman, XPS and TEM. The Cdots exhibit luminescence with a quantum yield of 2.2%, consistent with previously reported Cdots derived from similar raw material.³³

Advantageously, the production of Cdots using the VFD is under continuous flow and thus the process is scalable.

In the presence of H₂O₂, the as-received MWCNTs were disintegrated into regular shaped carbon dots with an average diameter of 6 nm (FIG. 10(a)). HRTEM of the Cdots show a lattice spacing between 0.2 to 0.25 nm confirming the presence of defects and oxidation (FIG. 10(c)).

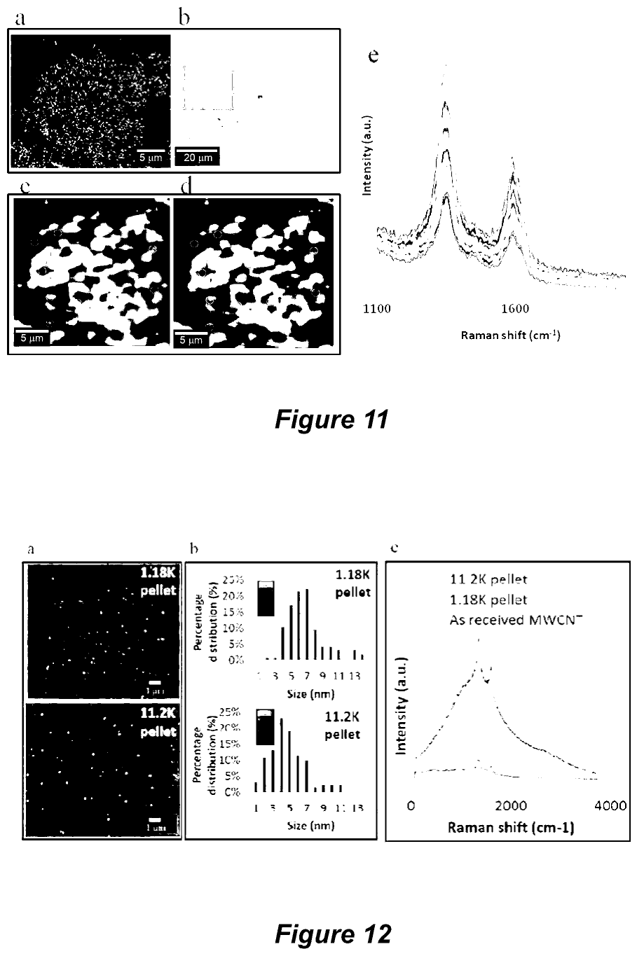

To further confirm the graphitic nature of the Cdots, Raman mapping using a 532 nm wavelength laser was conducted on a specific area with highly dense distribution of the Cdots (confirmed by SEM imaging) (FIG. 11). The strong intensity from the D and G band at peak positions at approximately 1350 cm⁻¹ and 1594 cm⁻¹ respectively confirms the crystalline graphitic nature of the material. The post processing solution containing the Cdots was first centrifuged at 1180×g to remove the bundles present in the sample post processing. The reaction was quenched by removing the H₂O₂ via ultracentrifugation (11200×g) and the pellet was re-dispersed in MilliQ water. The Cdots were separated based on size using density gradient ultracentrifugation, whereby at 1180×g, the Cdots collected were 7 nm in size and at 11200×g, the size of majority of the Cdots were 4 nm (FIG. 12). The Cdots exhibited a strong fluorescence as observed from the Raman analysis.

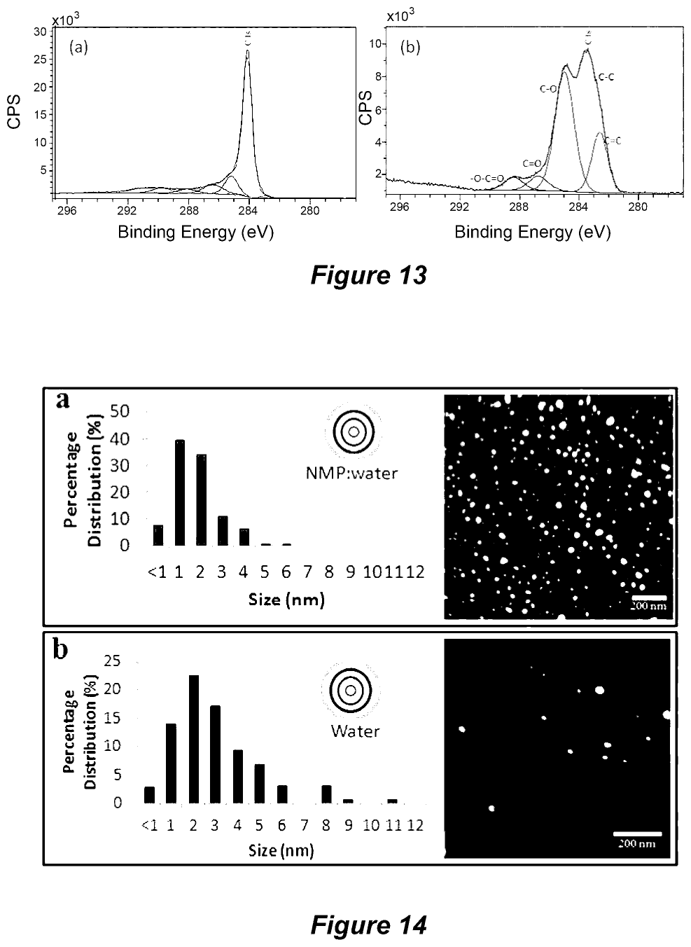

XPS spectra of the Cdots indicated a distribution of 70.5 at. % of C, 29.5 at. % of 0 compared to the as received samples with 98.46 at. % of C and 1.54 at. % of O (FIG. 13). The high content of oxygen confirmed the successful oxidation of the Cdots, which has very similar oxygen content when compared to Cdots prepared using concentrated acids²³. The fitted C 1s peak showed the abundance of the carbon functional groups of 16.74% C═C, 34.23% C—C, 39.96% C—O, 4.77% C═O and 4.3% O—C═O.

The preparation of Cdots by laser-assisted VFD processing is not limited to the current reported size range. The amount of hydroxyl radical generated is dependent on the H₂O₂ concentration and irradiation time of the pulsed laser^{30,31}. Thus, varying the concentration of H₂O₂ and the irradiation time from the pulsed laser can be used to produce Cdots with various sizes and higher yield. Controlling the size of Cdots is important in tuning the fluorescence properties of the particles. For instance, the excitation wavelength of Cdots can be red-shifted as the size of the particles increase³². In addition, Cdots fabricated using this method are ready to be employed in sequential chemical functionalisation because non-functionalised edges of Cdots are highly chemical-reactive³³. This can be used for emission tuning of functionalized Cdots which can be red-shifted when adding amine³⁴ or fluorine³⁵ groups and blue-shifted when N-doped³⁶.

An alternative method to fabricate Cdot with size distributions of <4 nm was also developed. The method involves oxidising as received MWCNTs using the previously published method.³ The oxidised MWCNTs (O-MWCNT) were then dispersed in a mixture of NMP/water at a 1:1 ratio to obtain high yielding Cdots with a size distribution of about 1 nm. Changing the solvent system was critical in terms of controlling the size of the particles with the fabrication of Cdots in water being possible under similar conditions but with lower yields, and with the Cdots with average size of approximately 2 nm. Upon acid reflux, the as received oxidised MWCNTs are separated via ultracentrifugation based on the different lengths to obtain more control over the size distribution of the Cdots, ideally producing a much narrower size distribution (FIG. 14).

The absence of laser radiation under the equivalent VFD conditions simply resulted in debundling of MWCNTs. To further decouple the effect of the VFD and the laser irradiation, a pulsed laser at an optimized power of 450 mJ was directed towards the CNTs dispersed in H₂O₂ mixed using a magnetic stirrer in a quartz cuvette rather than in a VFD tube. This resulted in minimal conversion of the MWCNTs into Cdots, with large bundles and aggregates of MWCNTs still present.

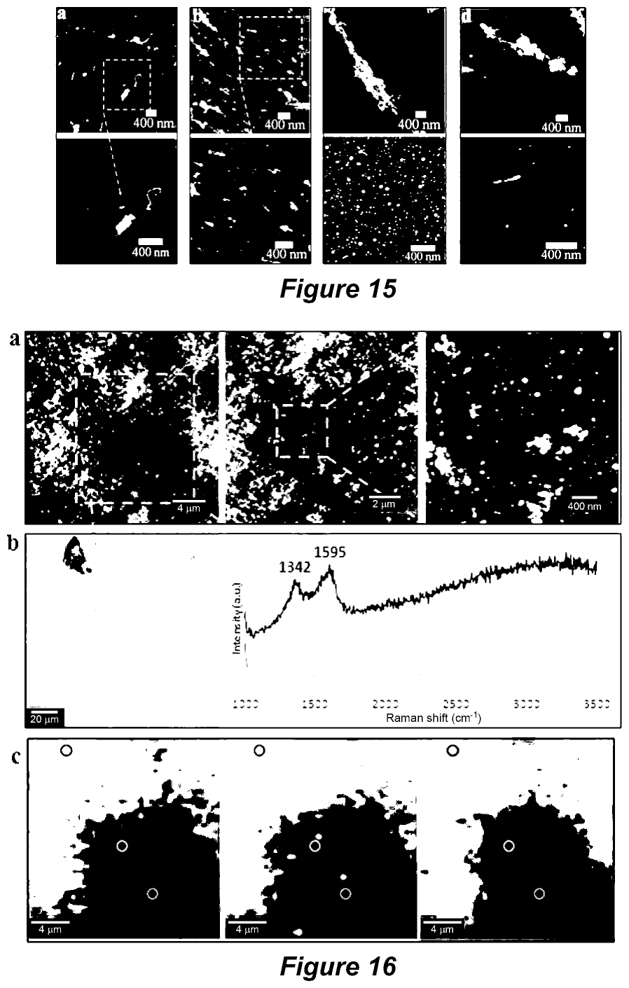

To determine the optimised conditions for fabricating the Cdots, as-processed samples were centrifuged at 1180×g to remove any aggregates or bundled nanotubes before atomic force microscopy (AFM). Operating parameters of the VFD and laser were systematically varied under continuous flow, changing one parameter at a time en route to the optimised conditions. For rotational speeds below 6500 rpm at a 45° tilt angle, apart from the presence of large bundles, short length CNTs (about 300 nm) were observed after processing (FIG. 15). At 7500 rpm, a significant amount of Cdots formed compared with all other rotational speeds conducted at the same laser power (FIG. 15), even though large bundles of long CNTs were still present. These optimal conditions (θ 45°, 7500 rpm) also correspond to the optimal processing condition for lateral slicing of carbon nanotubes using laser/VFD processing, similarly under continuous flow. At higher laser powers, between 450 and 600 mJ, small amounts of Cdots were observed along with bundled and aggregated CNTs, and at lower laser powers, ≤260 mJ, the conversion was ineffective and there was no clear band at the site of laser irradiation of the tube. The conversion was also ineffective at high laser power (>600 mJ) which might be due to the disturbance of the dynamic thin film as evidenced by the presence of large bundles of CNTs. We found that the position of the stainless steel jet feeds delivering solution to the base of the VFD tube needs to avoid direct irradiation by the laser. Otherwise a significant amount of metal oxide nanoparticles are generated, as evidenced by transmission electron microscopy (TEM), Raman and scanning electron microscopy (SEM)/energy dispersive X-ray spectroscopy (EDX).

Raman spectroscopy was used to verify the crystalline nature and degree of sp² hybridisation of the Cdots in comparison to the as-received MWCNTs. Processing with the laser operating at 532 nm showed lower Cdot formation and poorer sample homogeneity relative to those prepared under the optimised conditions (θ 45°, 7500 rpm rotational speed) using a NIR laser operating at 1064 nm (FIG. 16). This is based on the change of ratio between I_{D} (degree disorder in sp² hybridised carbon) and I_{G} (stretching of graphitic carbon) using a Raman map over a Cdots enriched area (AFM confirmed). A significant increase in the background intensity was evident for the Cdots which might imply fluorescence emission under Raman laser excitation at 532 nm.⁴⁴

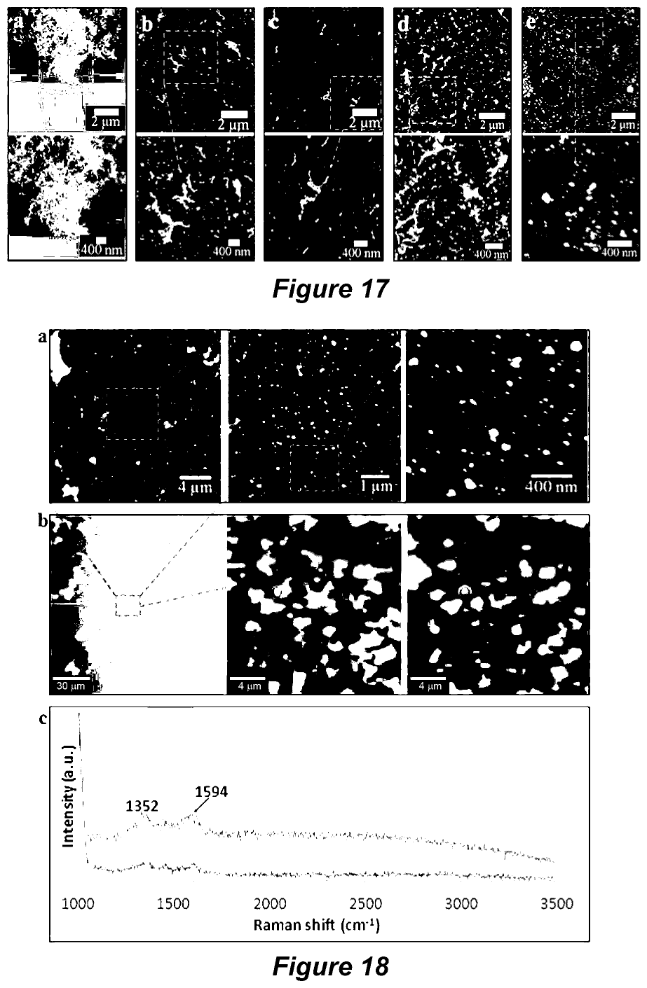

Post-VFD processing, centrifugation improved the sample purity by removing the large bundled CNTs but this led to a significant loss of Cdot material in the pellet. For generating practical quantities of the Cdots, no centrifugation was applied. The conversion of MWCNTs to Cdots may be further improved by lowering the starting material concentration from 0.5 to 0.1 mg/mL (FIG. 17). Two sequential continuous NIR laser-VFD cycles of the same sample (θ45°, 7500 rpm rotational speed, at 450 mJ laser power) further increased the conversion of the MWCNTs nanotubes to Cdots (FIG. 17e). This was confirmed using photoluminescence (PL) where the intensity of the second-cycled Cdots increased 11.8 times compared with one cycle processed material, but a reduction of Cdot yield revealed when three or more cycles was carried out.

After two cycles of laser-VFD processing, the Raman spectra of Cdots show a typical graphitic spectrum with the D-band at 1352 cm⁻¹ (1346 cm⁻¹ for MWCNTs), and the G-band at 1594 cm⁻¹ (1586 cm⁻¹ for MWCNTs) (FIG. 18). This blue shift of the G-band to a higher frequency and the disappearance of 2D peak at 2682 cm⁻¹ compared to as received MWCNTs is consistent with the surface oxidation of the CD, as reported by Islam et al.⁴⁵ for oxidized single layer graphene. The bandwidth of full width at half maximum (FWHM) significantly increased from 64 cm⁻¹ (as received MWCNTs) to 93 cm⁻¹ (CDs), which again is consistent with the oxidation state

TEM and AFM established that the as-prepared Cdots were quasi-spherical and showed an average height ca. 6 nm (from 3 to 13 nm) (FIG. 19). These are formed from fragmentation of 10 nm outer diameter MWCNTs. High resolution TEM (HRTEM) gave 0.21 nm and 0.34 nm lattice spacings, which correspond to the {100} and {002} planes of graphitic carbon.⁴⁷ This is in agreement with the spacing calculated from the diffraction pattern taken from the Cdots (inset of FIG. 19c). X-ray diffraction (XRD) for the as-received MWCNTs had peaks at 2θ 29.98° and 50.13° (weak) (FIG. 19d) which correspond to {002} and {101} atomic planes respectively for the hexagonal structured graphitic material.⁴⁸ XRD of Cdots had a broader peak at 2θ 29.04°, and their calculated interlayer d-spacing (d₀₀₂) is 0.34 nm which is in good agreement with the graphitic interlayer spacing.⁴⁹

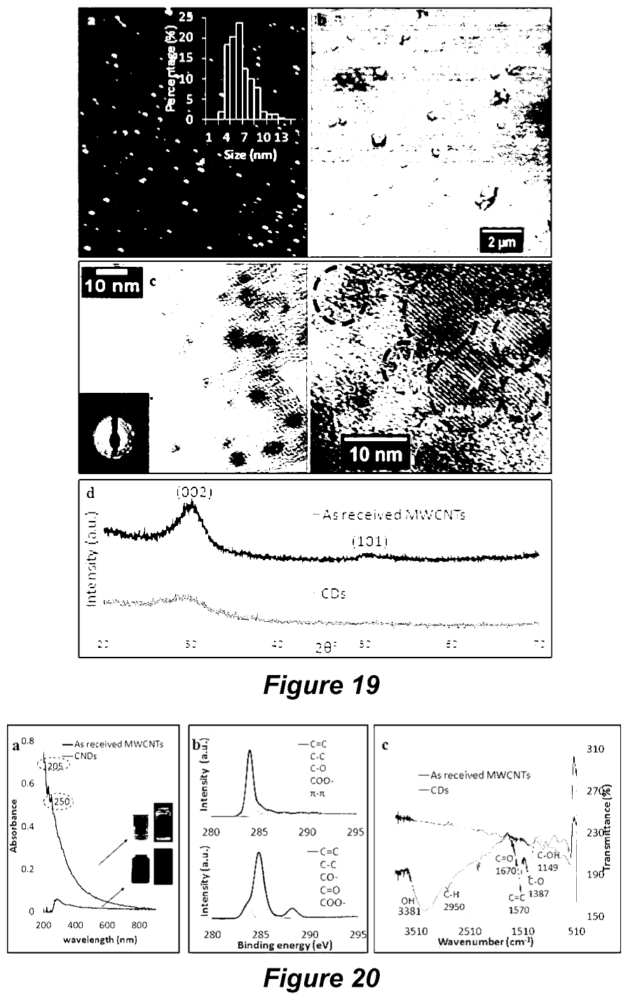

The Cdots obtained using the optimal processing conditions had good water solubility and colloidal stability, with little or no change in their optical properties over several weeks, and these are distinctly different from those of as received MWCNTs (FIG. 20a). The Cdots had a broad absorption spectrum with a tail extending into the visible region and this is attributed to the π-π* transition of the conjugated C═C bond (205 nm) and n-π* transition of C═O bond (250 nm). XPS established that the oxygen content increased significantly for as received MWCNTs (Oxygen content of 1.54%) compared to Cdots (Oxygen content of 18.7%). The Cdots were oxidized (C═C/C—C, 15.5% molar ratio), and deconvolution of the C 1s peak established atomic percentage of different types of C bonds—sp² (C═C at 284 eV, 12.2% molar ratio), sp³ (C—C/C—H at 285.2 eV, 65.0% molar ratio), C—O (285.7 eV, 11.4%), O—C═O (289.4 eV, 10.7% molar ratio) and π-π* interaction (shakeup, 290.9 eV) (FIG. 20b). The sp^{a} intensity is much stronger than the sp² which confirmed the oxidation of the Cdots relative to MWCNTs. FT-IR spectra of the Cdots gave characteristic absorption peaks for —OH stretching, 3381 cm⁻¹, and C═O stretching, ca. 1670 cm⁻¹(FIG. 20c). These findings agree with the XPS, XRD and HRTEM data. The formation of oxygen-containing functionality on the surface of the Cdots during the VFD processing while laser irradiated accounts for their water solubility.

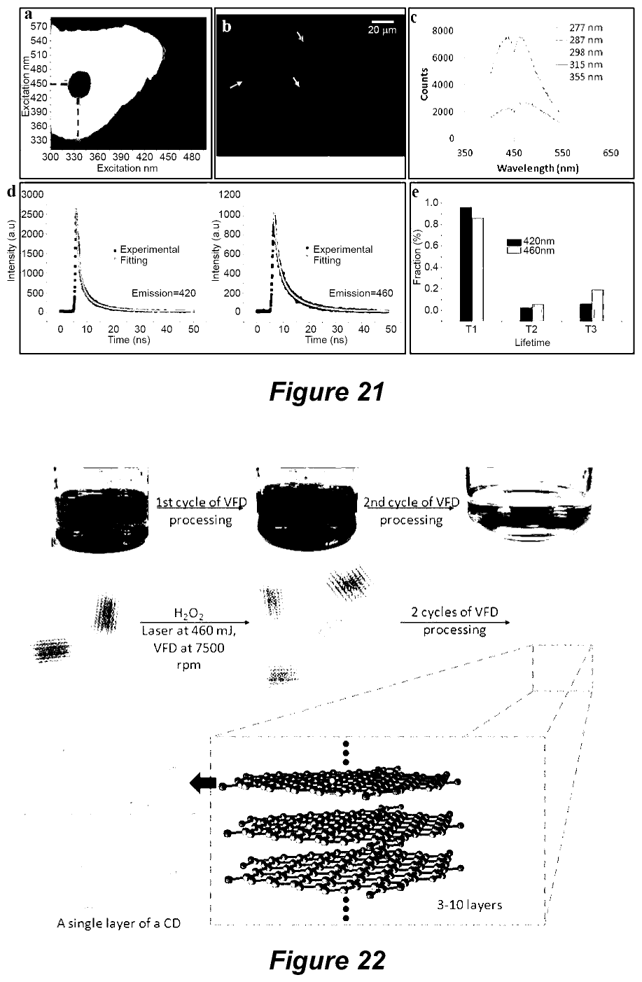

The scalability of the process was investigated by processing 50 mg of as received MWCNTs dispersed in 500 mL of H₂O₂. Approximately 40% of starting material was converted to Cdots, as deduced from residual material remaining in the syringe and the VFD tube post processing. The yield of dialysed Cdots which showed negligible cytotoxicity was ca. 10%, based on the total amount of initial MWCNT. 2D-Fluorescence maps of the Cdots showed a maximum excitation wavelength of 345 nm and an emission at 450 nm (blue in the visible region) (FIG. 21a) with the as-received MWCNTs showing no fluorescence. Drop-casted Cdots showed UV-excitable (at 365 nm) characteristics under the fluorescence microscope (FIG. 21b). Two resolved photoluminescence (PL) emission peaks at 420 and 460 nm (FIG. 21c) which were considered to be constant, meaning the emission is independent of the excitation wavelength (277-355 nm). Such excitation-independent PL emission is attributed to relative size uniformity. Fluorescence lifetime was analysed for both emission peaks under the excitation of a 377 nm pulsed laser (FIG. 21d). Both decay curves can be well fitted with a 3-component exponential model, which can be understood by the emission being an integration of at least three emissive sites (FIG. 21e). The fastest decay has a lifetime (τ1) about 1.4 ns, and the intermediate component has a lifetime (τ2) around 3 ns, while the slowest lifetime (τ3) is in the range of 8.5 to 9.0 ns. The lifetime results are consistent with a previous report³⁶ which attributes the PL of Cdots as arising from an integration of PL components from three types of emission centres, namely, σ*-n and π*-n transitions (emissions from functional groups dominate the blue side, corresponding to) τ1), π*-π transition (emissions from aromatic core of the Cdots, corresponding to τ2) and π*-midgap states-x transitions (emission normally on the red side dominated by the midgap states that are created by functional groups and defects, corresponding to τ3). Since the PL spectrum of Cdots shows two distinctive peaks centred at 420 and 460 nm, respectively, PL lifetime analysis was carried out for each emission peak. The percentage of the longer lifetime component era) of 460 nm emission is more than 13% higher than that of 420 nm emission, which indicates that the origin of 460 nm emission peak arises from stronger association with the surface functional group. Under both acidic (pH=1) and alkaline conditions (pH=12), PL of the Cdots was quenched, with the emissive peak at 460 nm under neutral conditions (pH=7) disappearing when the pH was adjusted either way, acidic or basic. This observation indicates that the emission peak at 460 nm is strongly associated with the surface functional groups, predominantly the —COO⁻ which is consistent with the XPS results. Either the H⁺ or OH⁻ cause the formation of non-radiative complexes with the surface functional groups of the Cdots and lead to static quenching.

AFM, TEM, Raman, FT-IR, XPS and PL of the Cdots are consistent with the proposed structure shown in FIG. 22. This corresponds well with what has been proposed in most studies, with Cdots having a graphitic core and an oxidized surface. Oxidation of the MWCNTs can occur at the ends of the nanotube or at defect sites on the sidewalls, which includes sp³-hybridised defects, and vacancies between the nanotube lattice or dangling bonds.⁵⁰ The surface functionalisation could be visually evaluated in terms of the solubility changes after the first laser-VFD cycle. Post-VFD processing, uncapped CNTs, nanometer-sized holes, shortened CNTs and disrupted side walls were evident. These could arise from oxidation of C—C bonds around initial defect sites.⁵¹ H₂O₂ may penetrate such defect sites, attacking the underlying C—C bonds causing further sidewall damage facilitated by laser irradiation. Raman spectroscopy of laser-VFD processed SWCNTs, DWCNTs and MWCNTs all showed significant increase in the I_{D}/I_{G} ratio, which is consistent with an increase in functional groups on the sample surface. Overall, this solvent initiated layer-by-layer degradation in the presence of laser irradiation and mechanical energy input from the VFD are collectively responsible in the fabrication of Cdots. Post-VFD processing, further tuning of fluorescence and chemical adoption is achievable. As-processed Cdots (dispersed in H₂O₂) and ethanol (ratio of 1:1) were eluted through an adsorption column packed with molecular sieve and magnesium sulphate. Different fluorescence properties were observed. Additionally, Cdots dispersed in H₂O₂ and ammonia (25%) (ratio 6:1) and heated at 60° C., as a variation of the method reported by Jiang et al,⁵² resulted in doping of N (1.46% XPS) but there was no change on the PL spectrum.

Thus, the processes described herein provide a simple and relatively benign method using a VFD to produce water soluble Cdots with scalability incorporated into the processing. At least one set of optimum operating parameters correspond to a sample concentration of 0.1 mg/mL, rotational speed of 7500 rpm, 0.45 mL/min flow rate, with a laser power of 450 mJ. The Cdots exhibit excitation wavelength dependent PL behavior with two distinctive emission peaks around 420 and 460 nm, being an integration of at least three emissive sites originated from the aromatic core, defects and functional groups. CDs are chemically reactive and could be potentially used for further chemical functionalisation. Importantly, VFD processing favours more product homogeneity in the dynamic thin film in the microfluidic platform, with product quality independent of the sample volume passing from the VFD.

It is envisaged that the intrinsic fluorescence of the Cdots may be tuned by controlling the size of Cdots which is crucial for red-shifting of the excitation wavelength. Furthermore, catalytic peroxidase enzymes, such as HRP and lignin peroxidase, may assist in accelerating the degradation of nanotubes in the presence of H₂O₂.

These processes for producing Cdots described herein are without precedent, with the ability to afford Cdots with uniformity in size and shape using a green chemistry approach. The method avoids the use of concentrated acids and stabilizing agents, avoiding by products and a much lower cost of processing.

Beside carbon nanotubes, there exist various inorganic nanotubes including boron nitride nanotubes (BNNTs), silicon nanotubes, gallium nitride nanotubes, titania nanotubes, tungsten(IV) sulphide nanotubes and composite boron, and carbon and nitrogen (BCN) nanotubes. Furthermore, there exist various inorganic nanowires, such as silver nanowires.

Using boron nitride nanotubes (BNNTs) as an example, BNNTs are structurally similar to CNTs, consisting of alternating B and N atoms arranged in a honeycomb crystal lattice affording a one atom thick hexagonal boron nitride layer. BNNTs are electrical insulators with a bandgap of approximately 5.5-5.8 eV which is independent of the direction and rolling vector of the BN sheets. Their wide band gap, high chemical and thermal stability and excellent mechanical properties make them ideal materials for nanodevices, high performance nanocomposite materials, biomedical applications such as drug delivery and most importantly for boron neutron capture therapy (BNCT)³⁷ and boron nitride capture in general, for example on the walls of space craft. Similar to CNTs, the issues pertaining to the processing of BNNTs involves strong aggregation of the long strands and the need to disperse them in organic solvents, which limits their potential for applications. For biological applications in specific, the long strands, which can be several microns in length, which can be highly toxic in biological samples, when introduced into the bloodstream³⁸.

We have developed a process to uniformly lateral slice inorganic nanotubes or nanowires and control the length devoid of surfactants, chemical functionalisation of the walls and in the presence of a benign solvent system. According to a sixth aspect, there is provided a process for slicing inorganic nanotubes or nanowires. The process comprises providing a solvent dispersion of starting inorganic nanotubes or nanowires and introducing the solvent dispersion of starting inorganic nanotubes or nanowires to a thin film tube reactor comprising a tube having a longitudinal axis, wherein the angle of the longitudinal axis relative to the horizontal is between about 0 degrees and about 90 degrees. The tube is rotated about the longitudinal axis at a predetermined rotational speed and the solvent dispersion of starting inorganic nanotubes or nanowires in the thin film tube reactor is exposed to light energy. Sliced inorganic nanotubes or nanowires are then recovered.

In certain embodiments of the sixth aspect, the angle of the longitudinal axis relative to the horizontal is about 45 degrees.

In certain embodiments of the sixth aspect, the light energy is provided by a laser.

In certain embodiments of the sixth aspect, the rotational speed is about 7500 rpm.

In certain embodiments, the laser operates at 1064 nm, 532 nm, 266 nm, or combinations thereof. In certain embodiments, the laser is a pulsed laser. In certain embodiments, the laser operates at a power of about 600 mJ.

In certain embodiments, the inorganic nanotubes or nanowires are selected from one or more of the group consisting of boron nitride nanotubes (BNNTs), silicon nanotubes, gallium nitride nanotubes, titania nanotubes, tungsten(IV) sulphide nanotubes and composite boron, carbon and nitrogen (BCN) nanotubes, and silver nanowires. In certain specific embodiments, the inorganic nanotubes or nanowires are BNNTs.

In certain embodiments of the sixth aspect, the solvent of the solvent dispersion is selected from one or more of the group consisting of: an alcohol, such as a C₁-C₆ alcohol; tetrahydrofuran; and ethers; an ionic liquid; a eutectic melt; and a supercritical solvent.

The process is scalable under the continuous flow mode of operation.

In certain embodiments of the sixth aspect, the process further comprises centrifuging the reaction product mixture and separating solid product comprising sliced inorganic nanotubes or nanowires from the supernatant.

Defects-free CNTs show significant improvement in electronic conductance and mechanical properties. According to a seventh aspect, there is provided a process for removing defects in single walled carbon nanotubes (SWCNTs). The process comprises providing a solution or dispersion of oxidised SWCNTs and introducing the solution or dispersion of oxidised SWCNTs to a thin film tube reactor comprising a tube having a longitudinal axis, wherein the angle of the longitudinal axis relative to the horizontal is between about 0 degrees and about 90 degrees. The tube rotated about the longitudinal axis at a predetermined rotational speed and the solution or dispersion of oxidised SWCNTs in the thin film tube reactor is exposed to light energy. The reduced defect SWCNTs are then recovered.

In certain embodiments of the seventh aspect, the angle of the longitudinal axis relative to the horizontal is about 45 degrees.

In certain embodiments of the seventh aspect, the light energy is provided by a laser. In certain embodiments, the laser operates at 1064 nm, 532 nm, 266 nm, or combinations thereof In certain embodiments, the laser is a pulsed laser. In certain embodiments, the laser operates at a power of about 260 mJ.

In certain embodiments of the seventh aspect, the rotational speed is about 7500 rpm.

In certain embodiments of the seventh aspect, the solution or dispersion of oxidised SWCNTs is formed by dispersing oxidized SWCNTs in water, a solvent or a mixture of water and a solvent. Suitable solvents include dipolar aprotic solvents and protic solvents. Examples of suitable solvents include, but are not limited to: N-methyl-2-pyrollidone (NMP), tetrahydrofuran, ethers, alcohols, ionic liquids, eutectic melts, and supercritical solvents.

In certain embodiments of the seventh aspect, the process further comprises forming oxidised SWCNTs from SWCNTs by treatment with an oxidant. The oxidant may be selected from one or more of the group consisting of: nitric acid; hydrogen peroxide; singlet oxygen generated in situ or otherwise; organic peroxides; bleach materials and the like; and reactive species from an oxygen plasma generated in situ in the VFD. In certain embodiments, the oxidant is nitric acid.

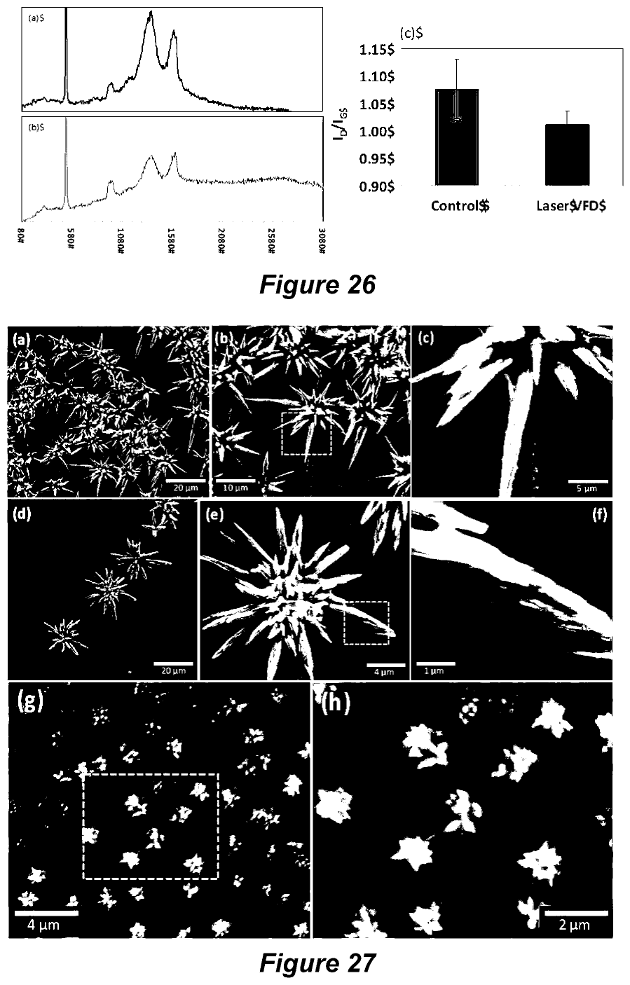

We observed that post VFD-laser processing, precipitation of O-MWCNT was observed in the VFD tube (FIG. 25a). Raman analysis of the precipitates indicates the removal of defects on the surface of the O-MWCNTs, resulting in more hydrophobic CNTs and thus precipitation in water. The Raman analysis of the precipitate also show a decrease in the I_{D}/I_{G}ratio compared to the supernatant and starting material, consistently demonstrating the removal of defects from the surface of the oxidized CNTs. The experiment was also conducted using pre-centrifuged O-MWCNT sample with the aim of removing all the possible bundles and agglomerates. A reduction on I_{D}/I_{G} ratio was again observed in two individual replicate experiments (FIG. 25b). Processing of oxidized SWNCT (O-SWCNT) under the same condition also showed a reduction of I_{D}/I_{G} ratio (FIG. 26).

Fullerene (C₆₀) can assemble into a variety of architectures offering unique properties with potential specifically in photovoltaics³⁹ and other electronic, magnetic and photonic applications.^{40,41} In organic photovoltaics in particular, there has been significant amounts of attention devoted towards developing novel materials of various morphologies and dimensions as donor materials. On this note, the self-assembly of fullerene, C₆₀ molecules into three dimensional microcrystals has been one of the most favoured carbon nanomaterial for its high surface, to be used in organic solar cells due its excellent electron conductivity and efficient charge separation capabilities at the electron donor/acceptor interfaces³⁹. The various architectures of nano and micron scale dimensions, using a green metrics approach, in being devoid of surface contaminating material, of high surface area would offer a route towards fabricating novel architectures for improved electrical conductivity and photoconductivity.

According to an eighth aspect, there is provided a process for forming supramolecular fullerene assemblies. The process comprises providing a fullerene solution comprising one or more fullerenes in a solvent and introducing the fullerene solution to a thin film tube reactor comprising a tube having a longitudinal axis, wherein the angle of the longitudinal axis relative to the horizontal is between about 0 degrees and about 90 degrees. The tube is rotated about the longitudinal axis at a predetermined rotational speed and supramolecular fullerene assemblies are recovered.

In certain embodiments of the eighth aspect, the angle of the longitudinal axis relative to the horizontal is about 45 degrees.

In certain embodiments of the eighth aspect, the rotational speed is from about 5000 rpm to about 800 ppm, such as about 5000 rpm, about 7500 rpm or about 8000 rpm.

In certain embodiments of the eighth aspect, the fullerene is selected from C₆₀, C₇₀, C₇₆, C₇₈ and C₈₄. In certain specific embodiments, the fullerene is C₆₉, but it is envisaged that mixtures of different fullerenes will form nano-structures of varying size, shape and morphology, and similarly for fullerene(s) in combination with other nano-materials, as detailed above, including sliced carbon nanotubes, carbon dots, and sliced boron nitride nanotubes.

In certain embodiments of the eighth aspect, the solvent is an aromatic solvent such as toluene, o-xylene, m-xylene, p-xylene and mesitylene, and/or any other solvent that solubilises C₆₀ and other fullerenes, as well as mixtures of solvents, and solvents containing surfactants.

The ability to organise fullerene C₆₀ molecules into flowerlike supramolecular assemblies was observed under controllable shear within dynamic thin films in the VFD. Using a solution of C₆₀ dissolved in toluene, the size and morphology of the flowerlike microcrystals were dependent on the concentration of the C₆₀/toluene solution and the rotational speed of the VFD. At a 45° inclination angle, the stable microcrystals rapidly form at room temperature, within minutes of processing time under the confined mode of operation. The size, dimensions and yield of the crystals was determined by the concentration of the C₆₀/toluene solution, 0.05 mg/mL and 0.1 mg/mL at rotational speeds of 5000 rpm and 8000 rpm (FIG. 27).

The formation of these distinct architectures devoid of surfactants is without precedent, and their accessibility is directly related to the high shear forces in the thin films in the VFD. The intense micromixing dramatically lowers the solubility of the fullerene, resulting in controlled nucleation and growth of such structures. The dynamic nature of the liquid also results in solvent evaporation under shear because of the waves and ripples in the thin film, effectively increasing the concentration of the fullerene in a given volume of liquid. However, the effect of evaporation is expected to be lower than the reduction in solubility associated with the high shear. Overall, the ability to fabricate functional nanocarbon material in this way is significant in the field, eliminating the need for annealing the nanostructures at high temperature and to remove any surfactants used to control the radial growth under diffusion controlled batch processing. Post shearing the fullerene material does not spontaneously re-dissolve, which is consistent with the well-known slow dissolution of the fullerene in a variety of solvents.⁴² The same outcome is then predictable for fullerene C₇₀ and other high fullerenes. Moreover, this phenomenon of reducing the solubility has general implications in solution processing, in accessing a material with control over the nucleation and growth of complex materials.

### EXAMPLES

### Example 1

### Controlling the Length of CNTs

SWCNTs were purchased from Sigma Aldrich, as chemical vapour deposition prepared material with an as-received purity >95%. Sample preparation included the addition of the SWCNTs (1 mg) into a sample vial containing a mixture of NMP and water (6 mL) at a 1:1 ratio. The solution mixture was then ultrasonicated for 5 minutes, affording a black stable suspension. Under the continuous flow of operation, jet feeds were set to deliver the CNT suspension (0.1 mg/mL) into the rapidly rotating 20 mm borosilicate NMR glass tube (ID 16.000±0.013 mm) at a rotating speed of 6500 rpm and at a tilt angle of 45 degrees. Simultaneously, a nanosecond pulsed laser processing system with an energy of approximately 600 mJ was applied to the rapidly rotating system for a period of time. Centrifugation (g 3.22) of the resulting solution for the confined mode of operation was required to remove any large agglomerates, unsliced bundled CNTs and impurities in the sample.

### Example 2

### Enriching Chirality of SWCNTs

The method involves the use of controllable mechanoenergy within dynamic thin films in the VFD while the tube is irradiated with a pulsed Nd:YAG laser operating at a wavelength 1064 nm at a laser power of about 260 mJ. Under both confined mode and continuous flow modes of operation of the device, as received SWCNTs comprising of a mixture of semiconducting and metallic chiralities undergoes lateral slicing and in situ conversion (interconversion) to afford metallic enriched SWCNTs. For the confined mode of operation, a finite volume of total liquid is required which was set at 1 mL. This ensures that a vortex is maintained to the bottom of the tube for moderate rotational speeds to avoid different shear regimes, and without any liquid exiting at the top the tube. Stewartson/Ekman layers prevail in the dynamic thin films, which arise from the liquid accelerating up the tube with gravitational force acting against them. The effectiveness of the process was then investigated under continuous flow, using jet feeds delivering the SWCNT dispersion into the rapidly rotating tube at a flow rate of 0.45 mL/min. These experiments used similar optimised conditions to what was established for the lateral slicing of CNTs. The VFD was at an inclination angle of 45° and a rotational speed of 7500 rpm.

### Example 3

### Dethreading of the DWCNT and MWCNT/Removing the Inner Shells

Preparation of aqueous suspensions of CNTs. DWCNTs were purchased from Carbon Allotropes with an as received purity >99%. p-Phosphonic acid calix[8] arene (p-H₂O₃ P-calix[8] arene) was synthesised following the literature method.⁴³ Milli-Q water was used for preparing the 10 mL aqueous suspensions of CNTs. Aqueous dispersions of DWCNT (1 mg) in water (6 mL) were prepared in the presence of p-phosphonic acid calix[8] arene (1 mg/L). Each solution mixture was ultrasonicated for 5 minutes, affording a black stable dispersion. Under the confined mode of operation of the VFD, the solution mixture (1 mL) was then placed in the glass tube and rotated at 7500 rpm, at a tilt angle of 45 degrees. Simultaneously, a nanosecond pulsed laser processing system with an energy of approximately 260 mJ was applied to the rapidly rotating system for 30 minutes. Under continuous flow mode, jet feeds with a flow rate at 0.45 mL/min deliver the CNT suspension (similar concentration, as for the confined mode) into the rapidly rotating tube. Centrifugation (g=3.22) of the resulting dispersion for the confined mode of operation was required to remove any large agglomerates, bundled CNTs and impurities in the sample. The suspension of DWCNTs was then further ultracentrifugated (g ˜16900) for 30 minutes to remove the excess calixarene. The centrifuge-washing step was repeated 3 times to ensure there was no excess calixarenes present. The above method was then repeated using a mixture of NMP and water (6 mL) at a 1:1 ratio.

### Example 4

### Controlling the Chirality of Carbon Nanoforms

SWCNTs (1.0 mg) were dispersed in toluene (3 mL) and added to MilliQ water (3 mL). Sonication for 10 minutes afforded a stable two-phase dispersion. A 1 mL portion of the mixture under sonication was collected to ensure that it was a uniform mixture of the three components, and was placed in a 20 mm (I.D=20.000±0.013 mm) or 10 mm (I.D=7.100±0.013 mm) diameter VFD tube, as standard borosilicate glass NMR tubes. The chirality of the ‘figure of 8’ was controlled by controlling the optical rotation of the borosilicate NMR tube in the VFD. A systematic evaluation of the operating parameters of the VFD was carried out to ascertain the optimal parameters for the formation of high yielding figure of 8 nanostructures to be at an inclination angle of 45° with the 20 mm VFD tube rotating at 7500 rpm, for a reaction time of 30 minutes. The diameters of the rings produced were within the range of 300 to 700 nm, as established using atomic force microscopy (AFM) and for a 10 mm diameter tube a significantly smaller diameter range, 100 to 200 nm was achieved (FIG. 8).

### Example 5

### Fabrication of Carbon Nanodots

MWCNTs were purchased from Sigma Aldrich, prepared using the chemical vapour deposition method with an as-received purity >98%. MWCNTs (10 mg) was dispersed in 60 mL of 30% H₂O₂ (˜0.2 mg/mL), following ultrasonication (˜5 minutes) to afford a stable black dispersion. Under the continuous flow mode of operation, the MWCNT dispersion was introduced into the rapidly rotating tube at a flow rate of 1 mL/min using optimized conditions of θ 45° and a rotational speed of 7500 rpm with a simultaneously nanosecond pulsed laser at 1064 nm (pulsed Q-switch Nd:YAG laser) operating at a power of ca 260 mJ. Centrifugation of the clear dispersion collected (1180×g) for 30 minutes was essential to remove bundled long MWCNTs and any impurities still present in the sample. The pellet containing the Cdots was washed multiple times with Milli-Q water. The washed Cdots were then dispersed in Milli-Q water and ultracentrifuged (11200×g) for 30 min. The Cdots with a yield of ˜62% were recovered for characterization purposes using SEM, AFM, Raman, XPS and TEM.

### Example 6

### Slicing of Boron Nitride Nanotubes

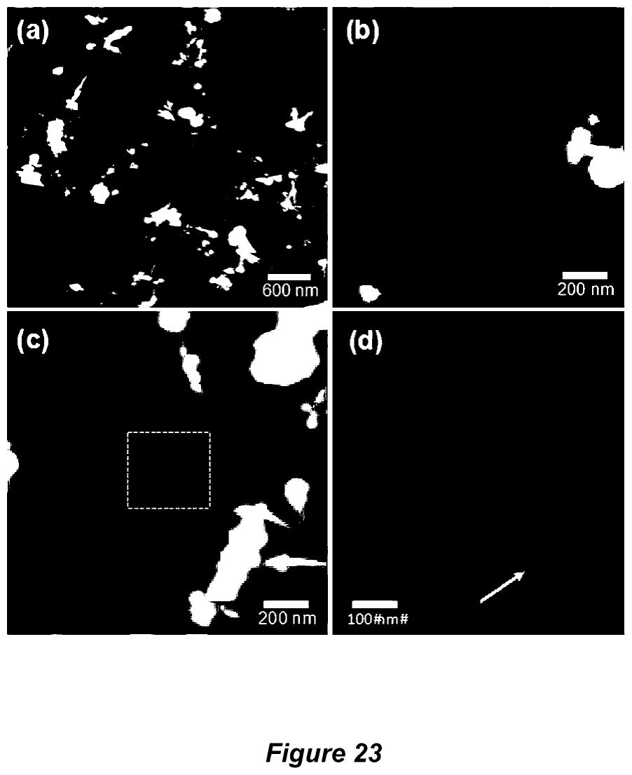

Boron nitride nanotubes (BNNTs) were purchased from Sigma Aldrich, with an average diameter of 5 nm±2 nm. BNNTs were dispersed in isopropanol (˜0.1 mg/mL), following ultrasonication (˜2 minutes) to afford a stable milky dispersion. Under the continuous flow mode of operation, the BNNTs dispersion was introduced into the rapidly rotating tube at a flow rate of 0.10 mL/min using an inclination angle, θ 45° and a rotational speed of 7500 rpm with a simultaneously nanosecond pulsed laser at 1064 nm (pulsed Q-switch Nd:YAG laser) operating at a power of ca 600 mJ. Centrifugation of the clear dispersion collected (1180×g) for 30 minutes was essential to remove bundled long BNNTs and any impurities still present in the sample. The sliced BNNTs were characterized SEM and AFM (FIG. 23).

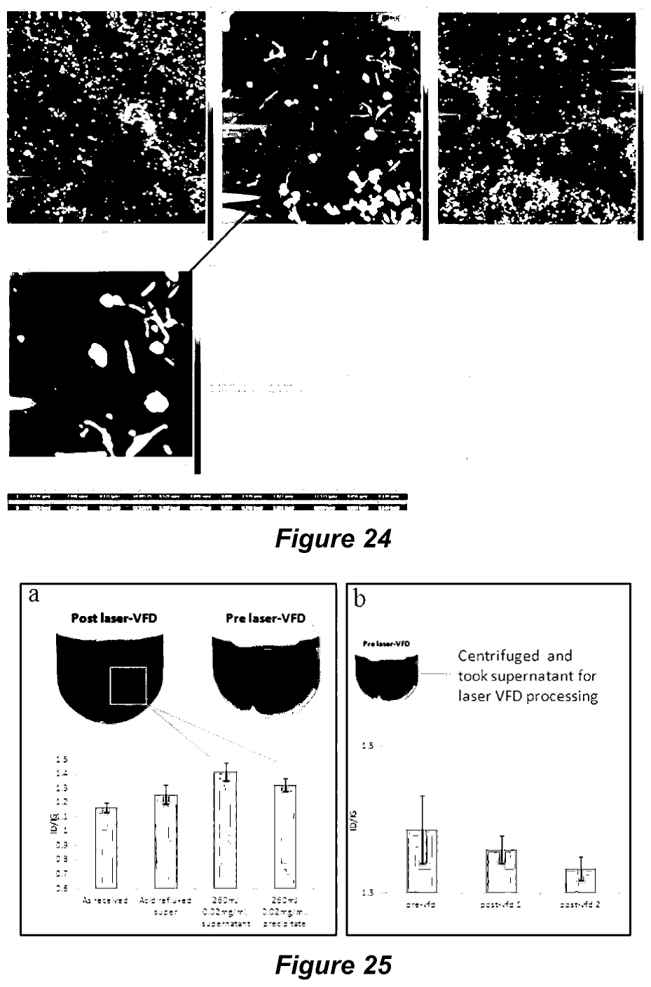

The sliced boron nitride nanotubes afforded are approximately 300-600 nm in length (FIG. 24).

### Example 7

### Removing Defects in CNTs

SWCNTs were purchased from Sigma Aldrich, prepared using the chemical vapour deposition method with an as-received purity >98%. As-received SWCNTs (0.3 g) were dispersed in 25 ml of the HNO3 (65 wt %) and reflux at 120° C. for 48 h. The resulting dispersion was diluted and washed using MilliQ water and filtered using a 0.45 μm membrane. The sample was dried in oven at 80° C.

For a typical experiment, the functionalized SWCNTs (0.1 mg) was dispersed in 1 ml of MilliQ water and was processed in the VFD (45 degrees inclination angle and a rotational speed of 7500 rpm) with a simultaneous pulsed laser (pulsed Q-switch Nd:YAG laser) at a 1064 nm wavelength at a laser power of 260 mJ for 30min. The post processed sample was soluble in MilliQ water and was then directly characterized using Raman spectroscopy (FIGS. 25 and 26).

### Example 8

### Controlled Self-Assembly of Fullerene C₆₀ Molecules

In a typical experiment C₆₀ (99685-96-8, 99+%, BuckyUSA) was added to toluene at different concentrations (0.05 mg/mL and 0.1 mg/mL) and the mixture allowed to stand overnight, whereupon it was filtered to remove any undispersed C₆₀ and impurities. C₆₀ dissolved in toluene (1 mL) was placed in in a glass tube, as a readily available borosilicate nuclear magnetic resonance (NMR) tube (ID 16.000±0.013 mm), which was spun for 30 minutes at an optimized speed of 5000 rpm and 8000 rpm respectively at an inclination angle of 45 degrees. For the confined mode of operation, a finite volume of total liquid is required which was set a 1 mL. The scalability of the process was then investigated under continuous flow, using one jet feeds delivering the above toluene solution of C₆₀ at a 0.45 mL/min. The C₆₀ nanostructures were characterized using SEM (FIG. 27).

### Example 9

### Controlled Self-Assembly of Fullerene C₆₀ Molecules

Fullerene C₆₀, with the purities of 99.5% and 99+% were purchased from Sigma Aldrich and Bucky US, respectively. Fullerene C₇₀ with 99.5% purity was purchased from Bucky US. Both fullerenes were directly used as received without any further purification. Toluene with a purity 99.9%, o-xylene, m-xylene, p-xylene, and mestlyine with purities ≥99% were also purchased from Sigma Aldrich, and used to dissolve the fullerenes. They were used to compare the influences of different solvents on the crystallisation of C₆₀ and C₇₀.

Solutions of C₆₀ were prepared at different concentrations, namely 0.05, 0.1 0.2, 0.5 and 1 mg/mL. This involved added solid material to the solvent, with the mixture left for 24 hours at room temperature.

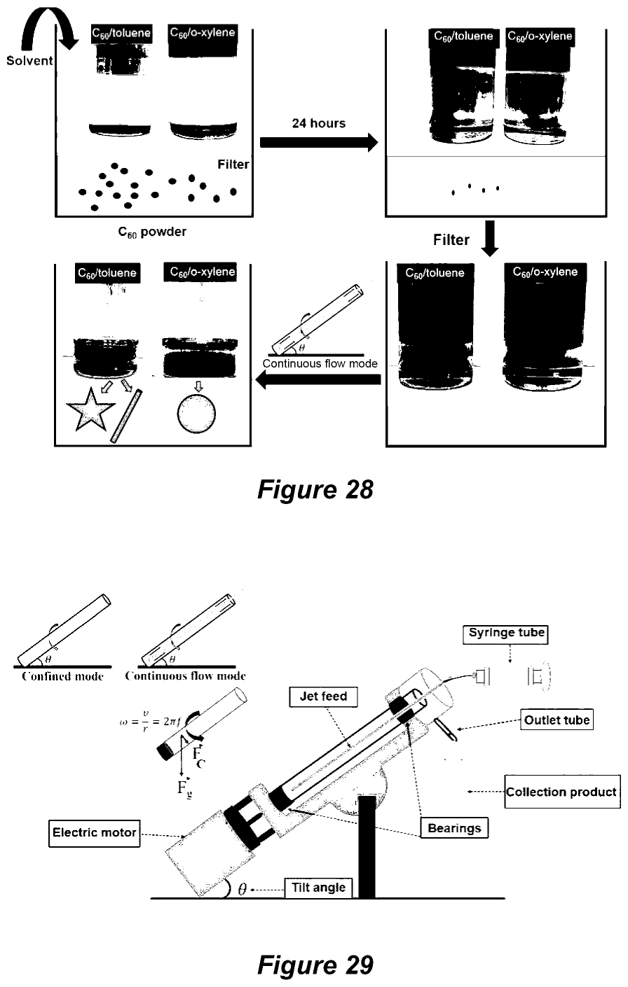

The samples were then filtered to remove undissolved particles and the supernatant were used immediately in the VFD experiments, as shown in FIG. 28. The confined mode was used initially for different speeds and a tilt angle of 45°, as an approach that has been effective for a number of applications of the VFD. For the confined mode, after addition of the solution of the fullerene, the solutions were kept rotating in the tube for about 30 min, giving all the experiments the same processing conditions. Then, this was adopted to the continuous flow mode, with a systematic approach in varying the speed, flow rate, tilt angle, and also concentrations. In continuous flow, the solution was injected into the hemispherical base of the rapidly rotating tube (20 mm borosilicate NMR glass tube with the inner diameter of 16.000±0.013 mm) through a jet-fed (FIG. 29). Rotational speeds were varied form 4 krpm up to 9 krpm, at different tilting angles of 0°, 15°, 30°, 45°, 60°, 75°. For experiments conducted under continuous flow, the solutions were collected at a time such that the processing is deemed uniform for the liquid entering and leaving the device. After optimizing the conditions for generating a specific shape, other aromatic solvents were explored (o, m and p-xylene and mesitylene). Finally, C₆₀ and C₇₀ were mixed with a volume ratio was fixed to be 1:1 as a feasibility study on the effect of the different fullerene in gaining access to other novel structures.

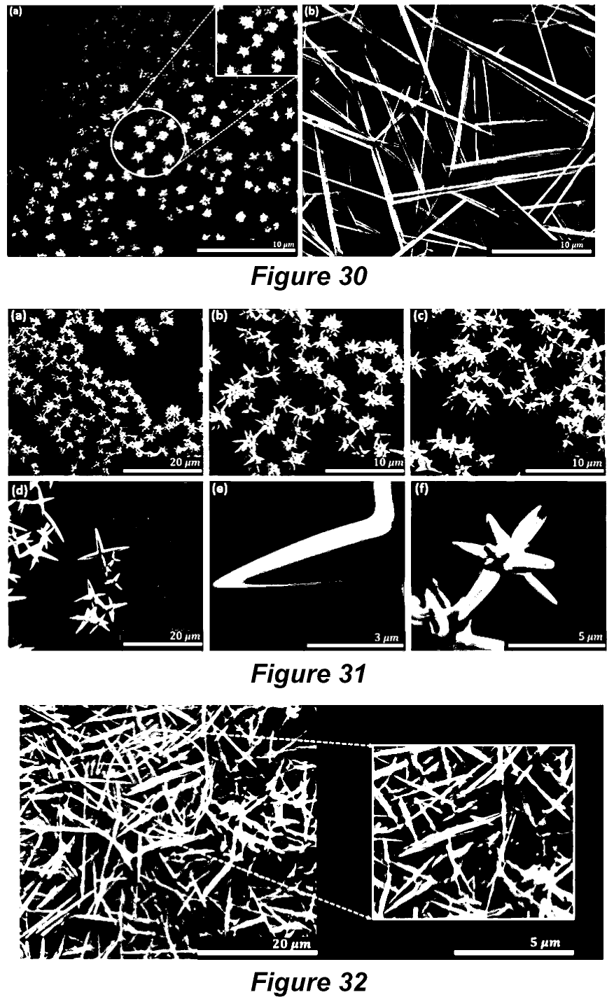

The two operation modes of the VFD confined mode (CM) and continuous flow mode (CF) were used in the formation of C₆₀ nano- and micron-sized particles. For CM, 1 mL of C₆₀ in toluene (concentration=0.05 mg/mL) was injected into the tube pre VFD processing, and this volume was used for all subsequent experiments to ensure that the fluid dynamic response is the same for a specific speed, at a fixed tilt angle of 45°. The rotational speed was varied from 5 krpm up to 8 krpm in imparting a diverse range of shear stress. Each CM experiment was carried out over 30 min, and thereafter the liquid was collected and processed. This involved centrifugation at 1.751 RCF, and collecting the precipitate by decanting, and filter it using filter paper. The solid material takes hours to redissolve (see below) such that there is sufficient time to collect the material with minimal re-dissolution post VFD processing. The optimal conditions were found at 5 krpm, and 7.5 krpm for C₆₀ assembled into stellated and rod like structures, respectively, as shown in FIGS. 30a and b.

Increasing the rotational speed increases the centrifugal force experienced by the liquid, based on the centrifugal force law:

F_{C}=m·ω²·r

where F_{C} is centrifugal force, in is mass, ω² is angular speed and r is reduce of rotation.

Thus, the higher the centrifugal force, the greater the cross vector of this force and gravitational force, resulting higher share stress in the thin films, with gravity pulling down the liquid and rotational forces directing the liquid up the tube. The difference in shear stress clearly affects the nature of the particles formed, as the solubility under shear decreases, with onset of nucleation and growth.

For scalable, continuous flow (CF) processing, the solution of fullerene C₆₀ was delivered into the hemispherical base of the inclined rapidly rotating tube via a jet feed, using a programmed syringe pump. This is while systematically exploring the parameter space of the VFD, namely rotational speeds, flow rate and tilt angle, along with concentration of the fullerene. The product was collected through the outlet tube at the top of the device, with the residence time for a finite volume of liquid depending on the flow rate, \dot{v} and rotational speed ω. With optimising conditions of concentration to 0.1 mg/mL (C₆₀ in toluene), \dot{v}=0.1 mL.min⁻¹, ω=4 krpm and θ=45°. Decreasing the flow rate results in increases the residence time and thus the time of shear stress as the liquid moves through the tube, results in self-assembled C₆₀ as stellated particles, close to uniform in size as shown in FIG. 31.

Studies were undertaken to further systematically explore the parameter space, in changing the speed, flow rate and tilt angles. Stellated C₆₀ particles were the sole product formed at ω=4 krpm, \dot{v}=0.1 mL/mm, C=0.1 mg/mL , θ=45°, as shown in FIG. 31. Variations in ω and θ with fixed \dot{v} did not result in a uniform product with respect to size and shape of the particles of C₆₀. Size and shape of the C₆₀ stellated-like particles was established using SEM, FIG. 31a. Lengths ranged from about 1.33 μm to 2.58 μm. The length of these microstructures was measured from the centre to edge of prism crystals. Fixing tilt angles at 45° and changing both rotational speeds and flow in the VFD resulted in self-assembled C₆₀ rods, with the optimal conditions at a rotational speed of 7 krpm rpm and flow rate of 1.0 mL/min, as shown in FIG. 32.

The ability to control the nucleation and growth of both stellated and rods of self-assembled C₆₀, without adding an anti-solvent, and without adding a surfactant is without precedent. Moreover, the stellated particles have not previously been reported. Normally the growth of particles of the fullerene requires an anti-solvent. The processes described herein were run in the absence of anti-solvent. Clearly, the shear stress in the dynamic thin film in the VFD reduces the solubility of C₆₀. Under high shear, it is hypothesised that the solvation shell stabilising individual fullerene molecules is disturbed leading to favourable fullerene-fullerene van der Waals interactions resulting in the nucleation and growth of self-assembled fullerene C₆₀. In addition, the ability to form different structures by changing the processing parameters of the VFD, in particular the rotational speed, 4 krpm and 7 krpm, most likely reflects different types for shear stress and fluid dynamic response in the thin film, for example transitioning from transient turbulence to turbulent flow. This shows that different rotational speeds (and different operating parameters of the VFD) can provide access to a multitude of particles with different sizes and shape.

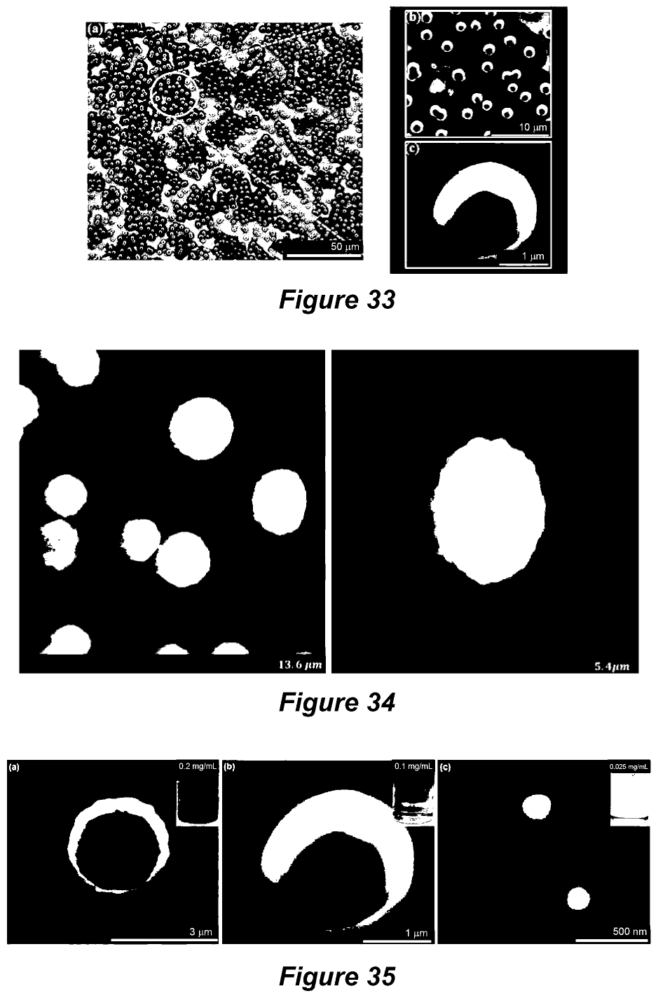

To investigate whether other structures could be accessed using the VFD the solvent was changed. This was firstly explored for o-xylene as a related methyl substituted aromatic molecule, and resulted in the formation of uniform material comprised of spherical-like particles of self-assembled C₆₀. The optimal operation parameters were a rotational speed of 4 krpm with the tube inclined at 45° and a flow rate of 1 mL/min, for a concentration of the solvated C₆₀ molecules in o-xylene at 0.1 mg/mL, as shown in FIG. 33 and FIG. 34. The size and shape of the C₆₀ spherical like particles was analysed using features of Nanoscope Analysis 1.4. The diameter of the C₆₀ spherical like particles are in the range of approximately 1.1 μm to 3 μm, and a height range of 372 nm to 755 nm.

The diameter of the C₆₀ spherical-like particles can be controlled by changing the concentration of C₆₀ in o-xylene, with the other parameters unchanged. For example, the average diameter was 3.5 μm for a concentration 0.2 mg/mL, whereas 1.8 μm and 150 nm particles were obtained by reducing the concentration to 0.1 mg/mL and 0.025 mg/mL, respectively, as shown in FIG. 35. The results here further highlight the effect of shear stress in reducing the solubility of C₆₀, leading to self-assembly into micro-nano spherical-like particles. Overall the effect of shear stress in the VFD is effectively equivalent to adding an anti-solvent, as for classical methods of crystallisation of the fullerene. This corresponds to changing the fluid dynamics from laminar flow in batch processing to transient turbulent/turbulent flow in the VFD. Transitioning from laminar flow to turbulent flow can be determined from the Reynolds equation:

$${R}_{e} = \frac{ρ u L}{μ} = uL \text{/} v$$

Therefore, at low number ˜Re<250, the flow will be laminar. For higher Reynolds numbers the fluid will transition to turbulent flow. In conventional channel based microfluidics the Reynolds numbers are typically low, corresponding to laminar flow. For the VFD modes (confined and continuous flow) the fluid flow is regarded as at least transitioning into turbulent flow, with the greatest shear for droplets striking the base of the tube resulting in this film instability with the formation of helical flow. The Reynolds numbers is the VFD are directly proportional to high speeds.

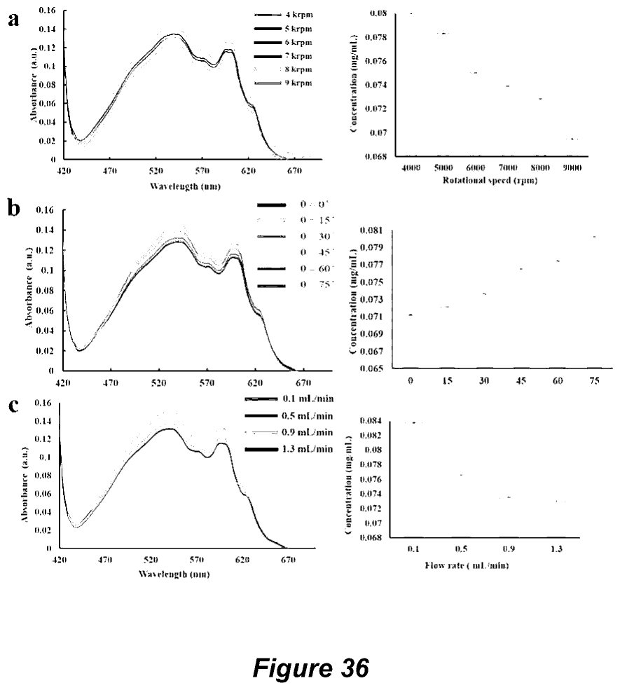

The change in operating parameters of the VFD will affect the time taken for a finite amount of liquid to enter and exit the tube, which is the residence time, i.e. t_{residence}=tᵢ−t_{f} where, tᵢ and t_{f} is the time taken for a first drop of liquid to reach the bottom of the tube and exit the tube. It also clear that the residence time will increase with increasing tilt angle, and that is due to increasing the gravitational force (F_{g}) resulting in decreasing the centrifugal force (F_{c}). This results in mixtures of shapes and size of the products with small size at low value of tilt angles. As an example, when the liquid is delivered to the bottom of the tube at flow rate of 1.0 mL/min, for the tube rotating at 8 krpm, the residence time is ˜01:20 min, whereas for a flow rate of 0.1 mL/min and the same speed, the residence time is ˜12.8 min. Decreasing the speed to 4 krpm for a flow rate of 0.1 mL/min, the residence time dramatically increases to ˜44.08 min, which is shown in FIG. 36. For high residence time there is significant loss of solvent due to high mass transfer associated with the formation of waves and ripples in the thin film. This needs to be taken into account in measuring the absorbance (A) of the liquid exiting the VFD with a reduction in A from both loss of solvent via enhanced evaporation and the nucleation and growth of the fullerene particles. For instance, with low speeds, flow rate and high tilt angle, the absorption is higher. Here the higher residence time will result in more evaporation. The concentrations can be determined using Beer's Law, knowing the molar absorptivity, ε, for fullerene C₆₀ in toluene at 540 nm is 933.

The particles of C₆₀ obtained from toluene and o-xylene, were also characterised using EDX and Raman spectroscopy. For the former, only carbon, and a small amount of silicon (25.14%) were observed. The presence of carbon is consistent with the material formed as self-assembled C₆₀ with the silicon arising from the substrate (silicon wafer) which was used in the study.

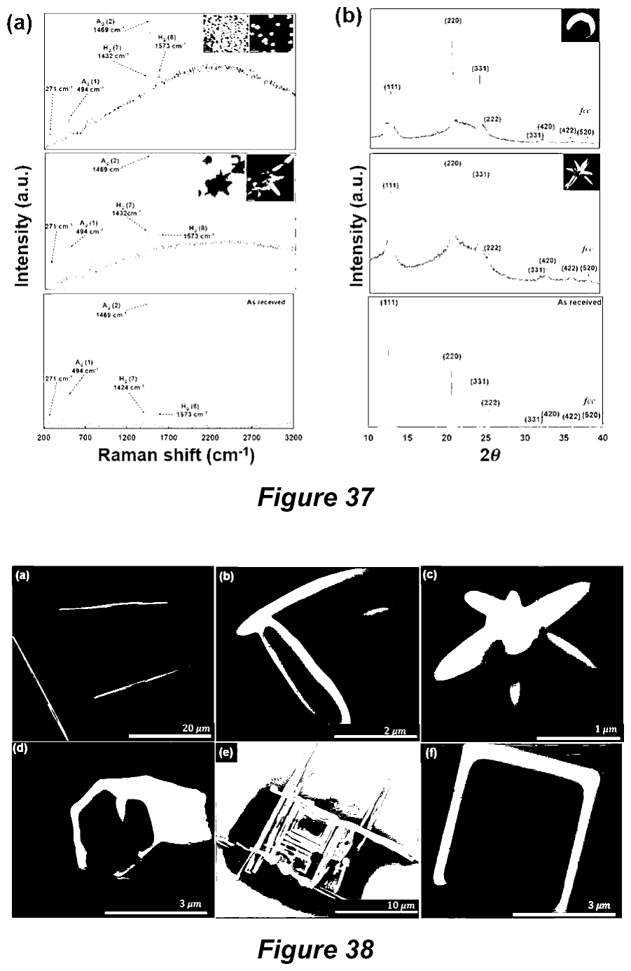

Another technique for characterising C₆₀ is Raman spectroscopy. FIG. 37(a) shows Raman spectra of as received C₆₀ as well as both stellated-like and spherical like particles obtained for C₆₀ solutions of toluene and o-xylene, respectively, prepared at the optimized processing parameters, as discussed above. Both particles have typical vibrational modes A_{g} and H_{g} corresponding to fullerene C₆₀, namely the Ag (Ag₁=494 cm⁻¹ and Ag₂=1469 cm⁻¹ and Hg (271 cm⁻¹, 1432 cm⁻¹, 1573 cm⁻¹). The position of the Ag₂ vibrational modes for both particles are not perturbed relative to as received C₆₀, and thus the fullerene molecules have not polymerised through the formation of covalent bonds, as for example 2+2 cycloaddition.

The crystal structures of both stellated and spherical like self-assembled C₆₀ were studied using X-ray powder diffraction. Both show three characteristic 2θ peaks corresponding to f_{CC} C₆₀, at 12.6°, 20.6° and 24.2° of 2θ values, which correspond to the (111), (220), and (311) planes FIG. 37(b). The broad base line peaks suggest the presence of some amorphous material. In addition, the particle size is calculated to be 7.8 nm using the Scherrer equation:

$$τ = \frac{k λ}{β cos θ}$$

The formation of f_{CC} crystalline material under high shear is noteworthy. This is the same phase of C₆₀ as formed using water as an anti-solvent in the VFD, which is the phase devoid of included solvent molecules, such that no additional processing is required of the fabricated particles of fullerene C₆₀.

Studies using other solvents for C₆₀ were also undertaken, using m-xylene and p-xylene and mesitylene and the results are shown in FIGS. 38(a) to (d).

A study was undertaken on a mixture of C₆₀ and C₇₀ (1:1 ratio) for different solvent systems and the results are shown in FIGS. 38(e) and (f). This resulted in a complex 3D structure and prisms, respectively. Thus, novel arrays of assembled C₆₀ and C₇₀ can be formed depending on the ratio and operating parameters of the VFD. This can be used to fine tune the properties of the material, for application in energy (solar cell), probe surface technology, medicine and water treatment.

An advantage of the processes described herein over conventional methods for forming C₆₀ particles is that no hazardous chemicals or surfactants are required. This means that the final structure will not include a solvent, whereas in the conventional methods heat is required to remove the solvent and this can affect the structure. Similarly, no surfactant is required for the processes described herein whereas it can be difficult to remove the surfactant used in some conventional methods. Using a single solvent enables recycling of the solution back through the VFD after dissolving more pristine fullerene C₆₀. Thus the ‘bottom up’ processing technology developed does not generate a waste stream once it is set up, with no heating or cooling required, and without the need to separate different solvents and without downstream processing to remove any included solvent.

### Example 10

### Controlled Self-Assembly of Fullerene C₇₀ Molecules

The processes described in Example 9 can also be used for producing particles of fullerene C₇₀. It is noteworthy that C₇₀ has enhanced conductivity and photoconductivity, fluorescence and optical limiting performance over C₆₀. Moreover, since C₇₀ is more expensive than C₆₀ and, therefore, making material from mixtures of the two fullerenes may provide access to other structures of particles. Indeed, growing novel material directly from raw fullerite (the mixture of fullerenes generated directly from graphite) may also be possible.

In the fullerene family, C₇₀ is the second most abundant form after C₆₀. Besides being readily available, liquid/liquid interface precipitation (LLIP) is the most conventional method for generating different shapes of crystals of self-assembled C₇₀. LLIP has been used to generate these structures, depending on experimental conditions and methods, especially on the choice of the solvent and surfactants. Even so, one shortcoming of the LLIP method is that it involves the use of hazardous and environmentally harmful reagents in forming the interface where the crystals are formed. Moreover, the surfactants used can also pose additional problems in that they can bind to the crystals and can affect the properties of the fullerene material.

In this Example, a greener approach is provided to control the growth of self-assembled fullerene into well-defined crystals under continuous flow using a vortex fluid device (VFD). Advantageously, the method developed is without the need for an anti-solvent, and the use of more toxic chemicals or surfactants. The postulation is that the shear stress disrupts the fullerene stabilising solvation shell, resulting in aggregation of the fullerene, and this results in the growth and nucleation of particles in the thin films formed as VFD microfluidic platform.

Particles of distinct size and specific shape can be fabricated using the VFD. Changing the various processing parameters influences the outcome of shear induced nucleation and growth of C₇₀ particles. While the tilt angle of the device was restricted to 45°, other parameters were varied, notably the flow rate, the choice of solvent, the rotational speed and the concentration of the fullerene. Clearly, the solubility of C₇₀ is greatly reduced as a result of the shear stress in the thin film, with the nucleation and growth of C₇₀ particles of specific size, shape and morphology, depending on the processing parameters. Uniformity in the size and shape of the particles can be achieved and indeed optimised. For instance, the particle can achieve shapes that closely resemble a uniform sphere or a cube.

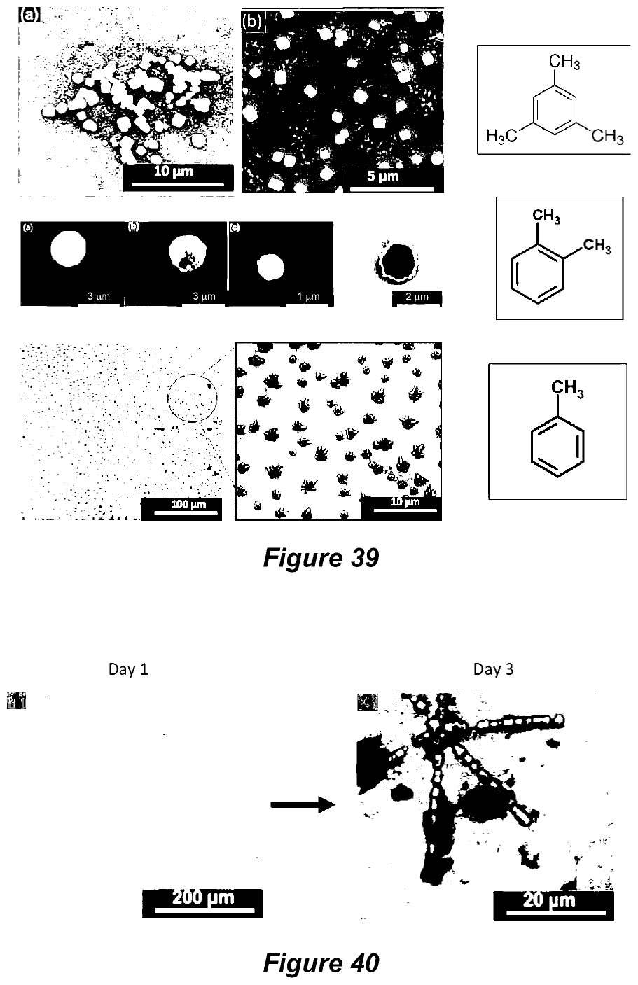

Three aromatic solvents were used to investigate the impact on the different choice of solvent, in highlighting the generality of the method, FIG. 39. It is also noteworthy that the time dependent phase transition shows the capability of the VFD in generating a material under a non-equilibrium states, and this has implications in further advancing the capabilities of the vortex fluidic device, FIG. 40.

Overall our results establish a breakthrough in controlling crystallization, without the need for using surfactants or anti-solvents. The shear induced crystallization is the forth form of crystallization that have been established, the others being sublimation, evaporation of solutions, and cooling of solutions.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

### REFERENCES

[1] Wong, E. W., Sheehan, P. E. & Lieber, C. M. Nanobeam Mechanics: Elasticity, Strength and Toughness of Nanorods and Nanotubes. Science. 277, 1971-1975, (1997).

[2] Zhang, J., Zou, H., Qing, Q., Yang, Y., Li, Q., Liu, Z., Guo, X. & Du, Z. Effect of chemical oxidation on the structure of single walled carbon nanotubes. J. Phys. Chem. B. 107, 3712-3718, (2003).

[3] Manivannan, S., Jeong, I. O, Ryu, J. H., Lee, C. S. Kim, K. S., Jang, J. & Park, K. C. Dispersion of single walled carbon nanotubes in aqueous and organic solvents through polymer wrapping functionalisation. J. Mater. Sci. 20, 223-229, (2009).

[4] Tkalya, E. E., Ghislandi, M., With, G. D. & Koning, C. E. The use of surfactants for dispersing carbon nanotubes and graphene to make conductive nanocomposites. Cur. Opin. Coll Inter. 17, 225-232, (2012).

[5] Mickelson, E. T., Chiang, I. W., Zimmerman, J. L., Boul, P. J., Lozano, J., Liu, J., Smalley, R. E. Hauge, R. H. & Margrave, J. L. Solvation of fluorinated single walled carbon nanotubes in alcohol solvents. J. Phys. Chem. B. 103. 4318-4322, (1999).

[6] Kostarelos, K. The long and short of carbon nanotube toxicity. Nature Biotechnology, 26, 774-776 (2008)

[7] Liu, L., Yang, C., Zhao, K. Li, J. & Wu, H. C. Ultrashort single walled carbon nanotubes in a lipid bilayer as a nanopore sensor. Nature Commun. 4, (2013).

[8] Javey, A., Guo, J., Paulsson, M., Wang, Q., Mann, D., Lundstrom, M. & Dai, H. High Field Quasiballistic Transport in Short Carbon Nanotubes. Phys. Rev. Lett. 92, 16804,(2004).

[9] Javey, A., Qi, P., Wang, Q. & Dai, H. Ten-to-50 nm long quasi ballistic carbon nanotube devices obtained without complex lithography. PNAS, 101, 13408-13410, (2008).

[10] Kalita, G., Adhikari, S., Aryal, H. R., Umeno, M., Afre, R., Soga, T. & Sharon, M. Cutting carbon nanotubes for solar cell applications. Appl. Phys. Lett. 92, 12358, (2008).

[11] Maynard, A. D. Are we ready for spray-on carbon nanotubes. Nat. Nanotech. 11, 490-491, (2016).

[12] Vimalanathan, K., Gascooke, R. J., Suarez-Martinez, I., Marks, N. A., Kumari, H., Garvey, C. J., Atwood, J. L., Lawrance, W. D. & Raston, C. L. Fluid dynamic lateral slicing of high tensile strength carbon nanotubes. Sci. Rep. 6, 22865, (2016).

[13] Vimalanathan, K., Chen, X. & Raston, C. L. Shear induced fabrication of intertwined single walled carbon nanotube rings. Chem Commun., 50 (77), 11245-11422 (2014).

[14] Mrakovcic, M., Meindl, C., Leitinger, G., Roblegg, E. & Frohlich, E. Carboxylated short single walled carbon nanotubes but not plain and multiwalled short carbon nanotubes show in vitro genotoxicity. Toxicol Sci. 144, 114-127 (2015).

[15] Tang, A. C. L., Hwang, G.-L., Tsai, S.-J., Chang, M.-Y Tang, Z. C. W., Tsai, M.-D., Luo, C.-Y., Hoffman, A. S. & Hsieh, P. C. H. Biosafety of non-Surface modified carbon nanocapsules as a potential alternative to carbon nanotubes for drug delivery purposes. PLoS ONE, 7 (2012).

[16] Yang, Z., Zhang, Y., Yang, Y., Sun, L., Han, D., Li, H. & Wang, C. Pharmacological and toxicological target organelles and safe use of single-walled carbon nanotubes as drug carriers in treating Alzheimer disease. Nanomedicine: Nanotechnology, Biology and Medicine, 6, 427-441(2010).

[17] Datsyuk, V., Kalyva, M., Papagelis, K., Parthenios, J., Tasis, D., Siokou, A., Kallitsis, I. & Galiotis, C. Chemical oxidation of multiwalled carbon nanotubes. Carbon, 46 (6), 833-840 (2008).

[18] Sun, X., Zaric, S., Daranciang, D., Welsher, K., Lu, Y., Li, X. & Dai, H. Optical properties of ultrashort semiconducting single walled carbon nanotube capsules down to sub-10 nm. J. Am. Chem. Soc. 130(20), 6551-6555 (2008)

[19] Dresselhaus, M. S., Dresselhaus, G & Avouris, P. Carbon Nanotubes: Synthesis. Structure, Properties and Applications. Springer-Verlag, 80, (2001).

[20] Liu, H, Nishide, D., Tanaka, T & Kataura, H. Large scale single chirality separation of single wall carbon nanotubes using simple gel chromatography. Nat. Common. 2 (2011).

[21] Krupke, R., Hennrich, F., Lohneysen, H & Kappes, M. M. Separation of metallic from semiconducting single walled carbon nanotubes. Science, 301, 344-347 (2003).

[22] Baker, S. N. & Baker, G. A. Luminescent carbon nanodots: emergent nanolights. Angew. Chem. Int. Edit., 49 (38), 6726-6744 (2010).

[23] Chua, C. K., Sofer, Z., Šimek, P., Jankovský, O., Klimová, K., Bakardjieva, S., Hrdličková Kučková, Š. & Pumera, M., Synthesis of strongly fluorescent graphene quantum dots by cage-opening buckminsterfullerene. ACS Nano., 9 (3), 2548-2555 (2015).

[24] Wang, Y. & Hu, A. Carbon quantum dots: synthesis, properties and applications. J. Mater. Chem., 2 (34), 6921-6939 (2014).

[25] Deng, J., Lu, Q., Mi, N., Li, H., Liu, M., Xu, M., Tan, L., Xie, Q., Zhang, Y. & Yao, S. Electrochemical synthesis of carbon nanodots directly from alcohols. Chem-Eur J., 20 (17), 4993-4999 (2014).

[26] Zuo, J., Jiang, T., Zhao, X., Xiong, X., Xiao, S. & Zhu, Z. Preparation and application of fluorescent carbon dots. J. Nanomater., 2015, 1-13 (2015).

[27] Roy, P., Chen, P. C., Periasamy, A. P., Chen, Y. N. & Chang, H. T. Photoluminescent carbon nanodots: synthesis, physicochemical properties and analytical applications. Mater. Today, 18 (8), 447-458 (2015).

[28] Zhai, X., Zhang, P., Liu, C., Bai, T., Li, W., Dai, L. & Liu, W. Highly luminescent carbon nanodots by microwave-assisted pyrolysis. Chem. Commun., 48 (64), 7955-7957 (2012).

[29] Hu, S. L., Niu, K-Y., Sun, J., Yang, J., Zhao, N-Q. & Du, X-W. One step synthesis of fluorescent carbon nanoparticles by laser irradiation. J. Mater. Chem., 19, 484-488 (2009)

[30] Kashima-Tanaka, M., Tsujimoto, Y. Kawamoto, K., Senda, N., Ito, K. & Yamazaki, M. Generation of free radicals and/or active oxygen by light or laser irradiation of hydrogen peroxide or sodium hypochlorite. J. Endodont., 29 (2), 141-143, (2003).

[31] Abdelfattah, M. M. Different types of laser use in teeth bleaching. J. Med. Med. Sci., 5 (10), 230-237, (2014).

[32] Ye, R., Xiang, C., Lin, J., Peng, Z., Huang, K., Yan, Z., Cook, N. P., Samuel, E. L. G., Hwang, C. C., Ruan, G., Ceriotti, G., Raji, A. R. O., Marti, A. A. & Tour, J. M. Coal as an abundant source of graphene quantum dots. Nat. Commun., (2013) doi:10.1038/ncomms3943.

[33] Buzaglo, M., Shtein, M. & Regev, O. Graphene quantum dots produced by microfluidization. Chem. Mater., 28 (1), 21-24 (2016).

[34] Jin, S. H., Kim, D. H., Jun, G. H., Hong, S. H. & Jeon, S. Tuning the photoluminescence of graphene quantum dots through the charge Transfer Effect of Functional Groups. ACS Nano., 7 (2), 1239-1245, (2013).

[35] Feng, Q., Cao, Q., Li, M., Liu, F., Tang, N. & Du, Y. Synthesis and photoluminescence of fluorinated graphene quantum dots. Appl. Phys. Lett., 102 (1), 0131111-0131114, (2013).

[36] Li, M., Wu, W., Ren, W., Cheng, H. M., Tang, N., Zhong, W. & Du, Y. Synthesis and upconversion luminescence of N-doped graphene quantum dots. Appl. Phys. Lett., 101 (10), 1031071-1031073, (2012).

[37] Goldberg, D., Bando, Y., Tang, C. & Zhi, C. Boron nitride nanotubes. Adv. Mater. 19, 2413-2437 (2007)

[38] Gao, Z., Zhi, C., Bando, Y., Goldberg, D. and Serizawa, T. Non covalent functionalization of boron nitride nanotubes in aqueous media opens application roads in nanobiomedicine. Nanobiomedicine 1(7), (2014)

[39] Shrestha, R. G., Shrestha, L. K., Khan, A. H., Kumar, G. S., Acharya, S. & Ariga, K. Demonstration of ultrarapid interfacial formation of 1D fullerene nanorods with photovoltaic properties. ACS Appl. Mater. Interfaces 6, 15597-15603 (2014)

[40] Guss, W., Feldmann, J. & Gobel, E. D. Fluorescence from X traps in C₆₀ single crystals. Phys. Rev. Lett., 72, 2644-2647, (1994)

[41] Saito, R., Fujita, M., Dresselhaus, G. & Dresselhaus, M. S. Electronic structure of on graphene tubules based on C₆₀. Phys. Rev. B., 46, 1804-1811, (1992)

[42] Ruoff, R. S., Tse, D. S., Malhotra, R. & Lorents, D. C. Solubility of fullerene C₆₀ in a variety of solvents. J. Phys. Chem., 97, 3379-3383, (1993)

[43] Clark, T. E., Makha, M., Sobolev, A. N., Su, D., Rohrs, H., Gross, M. L., Atwood, J. L. & Raston, C. L. Self-organised nano arrays of p-phosphonic acid functionalised higher order calixarenes. New J. Chem. 32, 1478-1483 (2008)

[44] Dilag, J.; Kobus, H.; Yu, Y.; Gibson, C. T.; Ellis, A. V. Non-toxic Luminescent Carbon Dot/Poly(dimethylacrylamide) Nanocomposite Reagent for Latent Fingermark Detection Synthesized via Surface Initiated Reversible Addition Fragmentation Chain Transfer Polymerization. Polym. Int. 2015, 64, 884-891.

[45] Islam, A. E.; Kim, S. S.; Rao, R.; Ngo, Y.; Jiang, J.; Nikolaev, P.; Naik, R.; Pachter, R.; Boeckl, J.; Maruyama, B. Photo-thermal Oxidation of Single Layer Graphene. RSC Adv. 2016, 6, 42545-42553.

[46] Brolly, C.; Parnell, J.; Bowden, S. Raman Spectroscopy: Caution When Interpreting Organic Carbon from Oxidising Environments. Planet. Space Sci. 2016, 121, 53-59.

[47] Cheng, J.; Wang, C.-F.; Zhang, Y.; Yang, S.; Chen, S. Zinc Ion-doped Carbon Dots with Strong Yellow Photoluminescence. RSC Adv. 2016, 6, 37189-37194.

[48] Thangaraj, R.; Kumar, A. S. Graphitized Mesoporous Carbon Modified Glassy Carbon Electrode for Selective Sensing of Xanthine, Hypoxanthine and Uric Acid. Anal. Method. 2012, 4, 2162-2171.

[49] De, B.; Karak, N. A Green and Facile Approach for the Synthesis of Water Soluble Fluorescent Carbon Dots from Banana Juice. RSC Adv. 2013, 3, 8286-8290.

[50] Czech, B.; Oleszczuk, P.; Wiacek, A. Advanced Oxidation (H₂O₂ and/or UV) of Functionalized Carbon Nanotubes (CNT-OH and CNT-COOH) and its Influence on the Stabilization of CNTs in Water and Tannic Acid Solution. Environ. Pollut. 2015, 200, 161-167.

[51] Xing, W.; Lalwani, G.; Rusakova, I.; Sitharaman, B. Degradation of Graphene by Hydrogen Peroxide. Part. Part. Syst. Char. 2014, 31, 745-750.

[52] Jiang, D.; Chen, Y.; Li, N.; Li, W.; Wang, Z.; Zhu, J.; Zhang, H.; Liu, B.; Xu, S. Synthesis of Luminescent Graphene Quantum Dots with High Quantum Yield and Their Toxicity Study. PLOS One 2016, 10, 1-15.

1-58. (canceled)

59. A process for producing a carbon nanotube product comprising predominantly carbon nanotube (CNTs) having a desired average length, the process comprising:
providing a composition comprising starting CNTs;
introducing the composition comprising starting CNTs to a thin film tube reactor comprising a tube having a longitudinal axis, wherein the angle of the longitudinal axis relative to the horizontal is between about 0 degrees and about 90 degrees;
rotating the tube about the longitudinal axis at a predetermined rotational speed;
exposing the CNT composition in the thin film tube reactor to laser energy at a predetermined energy dose; and
recovering the single walled carbon nanotube product comprising predominantly CNTs having a desired average length from the thin film tube reactor,
wherein the predetermined rotational speed is from about 6000 rpm to about 7500 rpm, the predetermined energy dose is from about 200 mJ to about 600 mJ and the values of the predetermined rotational speed and the predetermined energy dose are selected to produce CNTs having an average length of from about 40 nm to about 700 nm.

60. The process of claim 59, wherein the angle of the longitudinal axis relative to the horizontal is about 45 degrees.

61. The process of claim 59, wherein the predetermined rotational speed is 7500 rpm.

62. The process of claim 59, wherein the predetermined energy dose is 260 mJ.

63. The process of claim 59, wherein the composition comprising starting CNTs comprises water, a mixture of water and a solvent or a solvent.

64. The process of claim 63, wherein the solvent is selected from one or more of the group consisting of: N-methyl-2-pyrollidone (NMP), tetrahydrofuran, ethers, alcohols, ionic liquids, eutectic melts, and supercritical solvents.

65. The process of claim 59, wherein the CNTs having a desired average length of 40-50 nm or 150 nm.

66. The process of claim 65, wherein the composition comprising starting CNTs also comprises water.

67. The process of claim 59, wherein the CNTs having a desired average length have an average length of 200 nm.

68. The process of claim 67, wherein the composition comprising starting CNTs also comprises a mixture of N-methyl-2-pyrollidone and water.

69. The process of claim 68, wherein the N-methyl-2-pyrollidone and water are in a 1:1 ratio.

70. The process of claim 59, wherein the starting CNTs are pre-treated prior to formation of the composition comprising starting CNTs.

71. The process of claim 70, wherein the starting CNTs are oxidised prior to formation of the composition comprising starting CNTs.

72. The process of claim 59, wherein the composition comprising starting CNTs is introduced to the thin film tube reactor in a continuous flow and/or as a batch of fixed volume.

73. The process of claim 59, wherein a ratio of water and solvent in the composition comprising starting CNTs is used to control and/or vary the length of the CNTs formed.

74. The process of claim 59, wherein a pulsed laser of more than one wavelength or a continuous laser of other light sources is used to control and/or vary the length of the CNTs formed.

75. A process for fabricating carbon nanodots, the process comprising:
providing or forming an aqueous composition comprising oxidised multiwalled carbon nanotubes (MWCNTs);
introducing the aqueous composition to a thin film tube reactor comprising a tube having a longitudinal axis, wherein the angle of the longitudinal axis relative to the horizontal is between about 0 degrees and about 90 degrees;
rotating the tube about the longitudinal axis at a rotational speed;
exposing the aqueous composition in the thin film tube reactor to light energy; and
maintaining the tube at the rotational speed and exposing the aqueous composition to the light energy for a time sufficient to produce carbon nanodots.

76. A process for slicing inorganic nanotubes or nanowires, the process comprising:
providing a solvent dispersion of starting inorganic nanotubes or nanowires;
introducing the solvent dispersion of starting inorganic nanotubes or nanowires to a thin film tube reactor comprising a tube having a longitudinal axis, wherein the angle of the longitudinal axis relative to the horizontal is between about 0 degrees and about 90 degrees;
rotating the tube about the longitudinal axis at a predetermined rotational speed;
exposing the solvent dispersion of starting inorganic nanotubes or nanowires in the thin film tube reactor to light energy; and
recovering sliced inorganic nanotubes or nanowires.

77. A process for forming supramolecular fullerene assemblies, the process comprising:
providing a fullerene solution comprising one or more fullerenes;
introducing the fullerene solution to a thin film tube reactor comprising a tube having a longitudinal axis, wherein the angle of the longitudinal axis relative to the horizontal is between about 0 degrees and about 90 degrees;
rotating the tube about the longitudinal axis at a predetermined rotational speed;
recovering supramolecular fullerene assemblies.
